(19) United States
(12) Patent Application Publication
(10) Pub. No.: US 2026/0030915 A1
(43) Pub. Date: Jan. 29, 2026

(54) FLEXIBLE ACOUSTIC SENSOR SYSTEMS USING AN ACOUSTIC LENS

(71) Applicant: QUALCOMM Incorporated, San Diego, CA (US)

(72) Inventors: Jessica Liu STROHMANN, Cupertino, CA (US); Hrishikesh Vijaykumar PANCHAWAGH, Cupertino, CA (US)

(21) Appl. No.: 19/000,445

(22) Filed: Dec. 23, 2024

Related U.S. Application Data
(60) Provisional application No. 63/676,827, filed on Jul. 29, 2024.

(51) Int. Cl. G06V 40/13; G01S 7/52; G01S 15/89

(52) U.S. Cl. CPC G06V 40/1306; G01S 7/52079; G01S 15/8925

(57) ABSTRACT

Flexible acoustic sensor systems using an acoustic lens are disclosed. In some embodiments, an apparatus may include: a platen having an imaging portion associated with a surface of the platen; a flexible substrate including an acoustic sensing element; and an acoustic lens disposed between the platen and the flexible substrate, the acoustic lens having a curvature configured to expand a propagation angle range of one or more acoustic signals emitted from the acoustic sensing element such that an area associated with the imaging portion is larger than an area associated with the acoustic sensing element; wherein the flexible substrate is constructed to conform to the curvature of the acoustic lens. In some implementations, the platen may include a curved platen having a curved surface configured to contact the body part of the user; and the flexible substrate may be constructed to conform to a curvature of the curved platen.

### CROSS-REFERENCE TO RELATED APPLICATION

This application claims priority under 35 U.S.C. § 119 to U.S. Provisional Application No. 63/676,827, filed on Jul. 29, 2024, the contents of which are hereby incorporated by reference in its entirety for all purposes.

### TECHNICAL FIELD

This disclosure relates generally to devices and systems using acoustic sensing systems.

### DESCRIPTION OF RELATED TECHNOLOGY

A variety of different sensing technologies and algorithms are being implemented in devices. Sensing technology is ubiquitous in devices and can be used in various ways, such as identity and fingerprint detection, and biometric and biomedical applications, including health and wellness monitoring. Biometric authentication via fingerprint sensing is an example of an important feature for controlling access to devices or performing other operations. Some such sensing technologies are, or include, acoustic sensors including ultrasonic sensors. Performance can be limited in traditional sensing used with devices, including in emerging technologies such as flexible devices, including foldable displays. Although some previously deployed devices can provide acceptable results, improved applicability of sensing and detection systems in flexible devices would be desirable.

### SUMMARY

The systems, methods and devices of this disclosure each have several aspects, no single one of which is solely responsible for the desirable attributes disclosed herein.

In one aspect of the present disclosure, an apparatus is disclosed. In some embodiments, the apparatus may include: a platen having an imaging portion associated with a surface of the platen; a flexible substrate including an acoustic sensing element; and an acoustic lens disposed between the platen and the flexible substrate, the acoustic lens having a curvature configured to expand a propagation angle range of one or more acoustic signals emitted from the acoustic sensing element such that an area associated with the imaging portion is larger than an area associated with the acoustic sensing element.

In some implementations thereof, the platen may include a curved platen having a curved surface configured to contact a body part of a user; and the flexible substrate may be constructed to conform to a curvature of the curved platen.

In some implementations thereof, the flexible substrate may be constructed to conform to the curvature of the acoustic lens.

In some implementations thereof, the flexible substrate may be composed of polyimide and have a thickness of 10 to 50 μm.

In some implementations thereof, the acoustic sensing element may include an acoustic transmitter element and an acoustic receiver element disposed proximate to the flexible substrate; and the surface of the platen may be configured to contact a body part of a user.

In some embodiments, the apparatus may include: a curved platen including a curved surface having an imaging portion and configured to contact a body part of a user; and a flexible substrate including a sensing element; wherein: the flexible substrate is constructed to conform to a curvature of the curved platen; and the sensing element may include: an acoustic transmitter element configured to emit one or more acoustic signals from the sensing element toward the body part of the user through the curved platen; and an acoustic receiver element configured to detect one or more acoustic signals reflected from the body part of the user at the imaging portion of the curved surface.

In some implementations thereof, the curved platen may be configured to expand a propagation angle of the one or more acoustic signals emitted from the acoustic transmitter element such that an area associated with the imaging portion of the curved platen is larger than an area associated with the sensing element.

In some implementations thereof, the curved platen may be configured to allow propagation of the one or more acoustic signals emitted from the acoustic transmitter element such that an area associated with the imaging portion of the curved platen is substantially equal to an area associated with the sensing element.

In some implementations thereof, an acoustic lens may be disposed between the curved platen and the flexible substrate.

In some implementations thereof, the flexible substrate may be composed of polyimide.

In some implementations thereof, the body part of the user may include a finger, and the sensing element may include a fingerprint sensor configured to obtain fingerprint data through the curved platen; and the apparatus may further include a control system configured to perform an operation based on the fingerprint data.

In another aspect of the present disclosure, an acoustic sensing apparatus is disclosed. In some embodiments, the acoustic sensing apparatus may include: a platen configured to contact a body part of a user and including an imaging portion; an acoustic lens having a curvature configured to expand a propagation angle range of one or more acoustic signals emitted from the acoustic sensing element such that an area associated with the imaging portion is larger than an area associated with the acoustic sensing element; and a flexible substrate including an acoustic sensing element, wherein: the acoustic lens is disposed between the platen and the flexible substrate; and the acoustic sensing element may include: an acoustic transmitter element configured to emit one or more acoustic signals toward the body part of the user through the acoustic lens and the platen; and an acoustic receiver element configured to receive, through the acoustic lens and the platen, one or more acoustic signals reflected from the body part of the user at the imaging portion.

In some implementations thereof, the platen may include a curved platen having a curved surface configured to contact the body part of the user; the apparatus may further include a curved display element disposed between the curved platen and the flexible substrate; and the flexible substrate may be constructed to conform to a curvature of the curved platen and the curved display element.

In some implementations thereof, the body part of the user may include a finger, and the acoustic sensing element may include a fingerprint sensor; the one or more acoustic signals may be received responsive to the emission of the one or more acoustic signals and representative of fingerprint imaging data; and the apparatus further may include a control system configured to perform an operation using the fingerprint imaging data.

In another aspect of the present disclosure, a method of operating an acoustic sensor apparatus is disclosed. In some embodiments, the method may include: transmitting one or more acoustic signals toward an object of interest through an acoustic lens and a platen; receiving, at an acoustic sensing element of the acoustic sensor apparatus, one or more reflected acoustic signals from the object of interest; and performing an operation based on the received one or more reflected acoustic signals.

In some implementations thereof, the acoustic lens may be configured to expand a propagation angle range of the one or more acoustic signals, and increase an imaging area of an imaging portion at the platen of the acoustic sensor apparatus to be greater than a sensing area associated with an acoustic sensing element.

In some implementations thereof, the object of interest may include a finger of a user; the one or more reflected acoustic signals may be representative of fingerprint imaging data; and the operation may include fingerprint sensing based on the fingerprint imaging data.

In some implementations thereof, the platen may include a curved platen having a curved surface configured to contact a body part of a user.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram that shows example components of an apparatus according to some embodiments described herein.

FIG. 2A shows a block diagram representation of components of an example sensing system.

FIG. 2B shows a block diagram representation of components of an example mobile device that includes the sensing system of FIG. 2A.

FIG. 3A shows a side view of an example configuration of an ultrasonic sensor array capable of ultrasonic imaging.

FIG. 3B shows an example configuration of ultrasonic sensor array.

FIG. 4 is a cross-sectional diagram of a flexible acoustic sensor system using an acoustic lens, according to some embodiments.

FIG. 5 is a diagram of a flexible acoustic sensor system using an acoustic lens, according to some embodiments.

FIG. 5A illustrates a comparison of an area associated with a sensing element (such as a sensing element used with the acoustic sensor system of FIG. 5) and an area associated with an imaging portion at a surface of a platen (such as a platen used with the acoustic sensor system of FIG. 5), according to some examples.

FIG. 6 is a cross-sectional diagram of an example stack of materials usable with embodiments of the flexible acoustic sensor system disclosed herein.

FIG. 7 shows an example implementation of a sensor stack (e.g., the example stack of materials of FIG. 6) in a device.

FIGS. 8A and 8B each show a diagram of a flexible acoustic sensor system using multiple acoustic lenses, according to some embodiments.

FIG. 9 is a cross-sectional diagram of a flexible acoustic sensor system using a curved platen, according to some embodiments.

FIG. 10 shows a flow diagram of an example method of operating a flexible acoustic sensor, according to some embodiments.

Like reference numbers and designations in the various drawings indicate like elements.

### DETAILED DESCRIPTION

The following description is directed to certain implementations for the purposes of describing various aspects of this disclosure. However, a person having ordinary skill in the art will readily recognize that the teachings herein can be applied in a multitude of different ways. Some of the concepts and examples provided in this disclosure are especially applicable to user sensing applications. For example, fingerprint detection can be performed using the disclosed embodiments. However, some implementations also may be applicable to other types of sensing applications including biometric sensing, as well as to various other systems. The described implementations may be implemented in any device, apparatus, or system that includes an apparatus as disclosed herein. In addition, it is contemplated that the described implementations may be included in or associated with a variety of electronic devices (which may also be referred to herein simply as “devices” or a “device”) such as, but not limited to, mobile telephones, multimedia Internet-enabled cellular telephones, mobile television receivers, wireless devices, smartphones, smart cards, tablets, wearable devices such as bracelets, armbands, wristbands, watches, smartwatches, rings, headbands, patches, chest bands, anklets, etc., Bluetooth® devices, personal data assistants (PDAs), wireless electronic mail receivers, handheld or portable computers, netbooks, notebooks, smartbooks, printers, copiers, scanners, facsimile devices, global positioning system (GPS) receivers or navigators, cameras, digital media players, game consoles, wrist watches, clocks, calculators, television monitors, flat panel displays, electronic reading devices (e.g., e-readers), mobile health devices, computer monitors, auto displays (including odometer and speedometer displays, dashboard displays, etc.), cockpit controls and/or displays, camera view displays (such as the display of a rear view camera in a vehicle), architectural structures, microwaves, refrigerators, stereo systems, cassette recorders or players, DVD players, CD players, VCRs, radios, portable memory chips, washers, dryers, washer/dryers, parking meters, automobile doors, Internet of Things (IoT) devices, palm scanners, or point-of-sale (POS) terminals. Thus, the teachings are not intended to be limited to the specific implementations depicted and described with reference to the drawings; rather, the teachings have wide applicability as will be readily apparent to persons having ordinary skill in the art.

Modern devices include various functionalities and hardware that support the functionalities. As but one example, fingerprint sensing using a sensor is one such function of a device. In some embodiments, acoustic imaging, e.g., via transmission and receipt of ultrasonic signals by an acoustic transmitter element and an acoustic receiver element of the fingerprint sensor, may be used to obtain the fingerprint data.

As an aside, toe prints can be used to identify users because they are unique and permanent, similar to fingerprints. Toe prints have ridge (raised portions) patterns and furrows (recessed portions, otherwise known as valleys) similar to fingerprints. Similar to fingerprints, toe prints have unique features referred to as minutiae points that can differentiate one person from another. The whorls, ridges, valleys, and furrows in toe prints develop uniquely in each person. Therefore, the embodiments described herein can be used with toes for equal effectiveness as with fingers. Palms and feet may also be used for identification using unique features. However, toes, palms and feet are used less often for identification, particularly with aforementioned types of devices. For simplicity, “fingerprint” in the context of the present disclosure may refer to fingerprints, toe prints, palm prints, or footprints, and “finger” may refer to fingers, toes, palms, or feet.

Fingerprint sensing can be used by software and applications (apps) usable with a device to biometrically authenticate a user. Fingerprint data obtained using a fingerprint sensor may be used by the device to identify an object (such as a finger or fingerprint), change an operative state of the device, and/or perform other operations with the device (unlock or lock the device, initialize an application, authenticate a user, etc.). Some devices may be configured such that the sensor (such as a fingerprint sensor) is disposed beneath a display or other surface, which in cases of some devices (smartphone, tablets, etc.) may be a screen or other user interface.

Fingerprint sensors are thus useful for various purposes and are usable with various types of devices and/or displays. However, there are performance limitations when it comes to certain devices. As one example, flexible or foldable devices, when using typical sensors do not have the level of sensing performance that can be seen with, e.g., flat-panel displays. As a more specific example, ultrasonic signals transmitted or received by conventional sensors in conventional foldable displays or display stacks may have a transmission rate or a signal strength that is as little as 25-35% of that of an OLED (organic light-emitting diode) panel or a plastic OLED (POLED). As acoustic sensing often uses plane-wave propagation, weak signals are a challenge especially in fingerprint sensing with flexible (e.g., foldable) devices. As consumer devices and display technologies continue to mature, and flexible displays become more applicable in existing and emerging technologies, improving the performance of sensors in such flexible devices (which may include or utilize curved surfaces or displays or screens) can improve user experience and allow the sensors to be used with many types of devices and other objects.

In some embodiments described in the present disclosure, an acoustic (e.g., ultrasonic) sensor apparatus or system may include a stack of materials comprising a sensor element and other components that enable propagation and detection of acoustic signals. The sensor apparatus may have physically flexible and pliable properties so as to allow the sensor apparatus to conform to a non-planar surface, such as a curved or rounded surface, or a surface that can be deformed to be curved or rounded along at least one axis. For example, the sensor apparatus may be used with a foldable device or a device having a curved surface or platen. The stack may include materials to enable the flexibility and pliability of the sensor apparatus, such as a flexible substrate composed of polyimide in some embodiments, or other types of polymers in other embodiments.

In addition, the stack may be used in conjunction with an acoustic lens that is, in some embodiments, configured to disperse at least some acoustic waves generated at the stack at propagation angles that are not parallel, e.g., spherically from the sensor element, which may expand the range of propagation angles of the acoustic waves and results in an imaging area of an imaging portion at a surface of a platen which is larger than the sensing area associated with the sensor element. In some implementations, the acoustic lens may be constructed to have a curved surface adjacent to the stack to which the stack (including the flexible substrate) may conform. In some cases, the flexible substrate and the sensor stack may be directly laminated to the acoustic lens using an adhesive layer. The acoustic lens may, in turn, be coupled with a platen, such as a display or another surface. In some configurations, the platen may be a flat surface, a curved surface, or a flexible surface (e.g., a foldable display) that can alter its curvature.

In some embodiments, the platen may be a curved platen, and an acoustic lens may not be used. The curved platen may be coupled with the sensor stack without the acoustic lens in between. In such embodiments, the platen itself may (or may not) be configured to disperse at least some acoustic waves generated at the stack. However, in some implementations, an acoustic lens may be disposed and used between the curved platen and the sensor stack.

As such, the acoustic signal propagation angle range (the acoustic “field of view”) of a sensor element may be increased to capture information (e.g., acoustic data such as fingerprint data) in an imaging area (e.g., an area associated with an imaging portion at a surface of the platen) that is larger than the sensing area (e.g., an area associated with a surface of the acoustic transmitter and/or the acoustic receiver).

Particular implementations of the subject matter described in this disclosure can be implemented to realize one or more of the following potential advantages. The configurations disclosed herein may enable acoustic sensors to be utilized in various types of surfaces (e.g., curved or distorted surfaces) and/or flexible devices (e.g., foldable displays) by using a flexible stack. Moreover, by using an acoustic lens to expand the imaging area, the footprint of the sensor apparatus on the device can be maintained or lowered relative to the larger imaging area. Using the same amount or smaller active area of the sensor apparatus would desirably reduce the sensor's size, cost, and power usage. In addition, acoustically imaging a larger area of an object of interest to be sensed (e.g., a finger of a user) with a relatively smaller and/or denser sensor may improve the security and reliability associated with the imaging data (e.g., fingerprint data for authenticating a user) and potentially enable more fingerprint data to be collected over the larger imaging area.

Additional details will follow after an initial description of relevant systems and technologies.

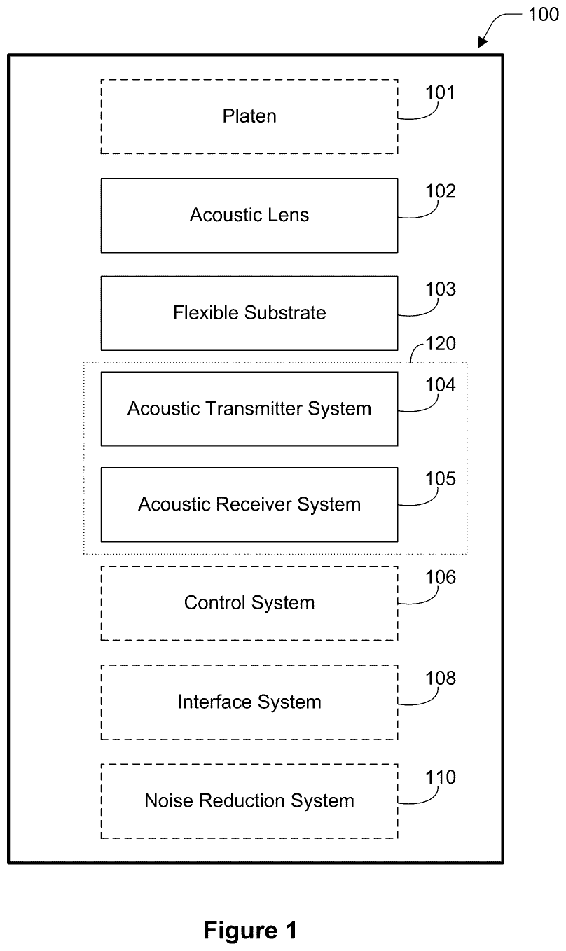

FIG. 1 is a block diagram that shows example components of an apparatus 100 according to some implementations. In some example embodiments, the apparatus 100 may include a platen 101, an acoustic lens 102, a flexible substrate 103, an acoustic transmitter system 104, and an acoustic receiver system 105.

Some implementations of the apparatus 100 may include a control system 106, an interface system 108, a noise reduction system 110, or a combination thereof.

In some configurations, apparatus 100 may be a sensor, sensor apparatus, or a sensing system usable with an electronic device such as that listed elsewhere above. In some configurations, apparatus 100 may be part of the device or another apparatus.

In some embodiments, the platen 101 may be or include a surface of a device. In some applications, platen 101 may be separate from a sensing element (e.g., acoustic transmitter system 104 and acoustic receiver system 105) of the apparatus 100. Some examples of a platen 101 may include a display element, such as an OLED panel or another flat-panel display, or a flexible display, or a layer of a stack of materials of a display. The platen 101 may at least partly include a visually and/or optically transparent portion. While platens generally have rigid and inflexible surfaces, the platen 101 disclosed herein may not be so rigid. In various implementations, platen 101 may include a surface that is capable of bending, folding, or other distortions, or it may be fixed at, or as, a curved surface. To achieve this flexibility, platen 101 may be composed of a polymer such as polyethylene, parylene, polystyrene, polyurethane rubber, or another flexible material. In further examples, the platen 101 may be a surface of an object such as the handle of a steering wheel of a vehicle (which typically has a curved geometry similar to a torus), a curved edge of a touchscreen, a surface of a mobile device such the side of a headset, a surface of a controller such as a handheld and/or wireless controller for controlling or interacting with extended reality (XR) (including virtual reality (VR), augmented reality (AR), mixed reality (MR), a wristwatch or wristband, a doorknob or handle, a pole or pole-shaped object or device, a wall, an electronic device listed above, or other surfaces of an object or device that may be communicatively and/or physically coupled with an electronic device or other computerized apparatus.

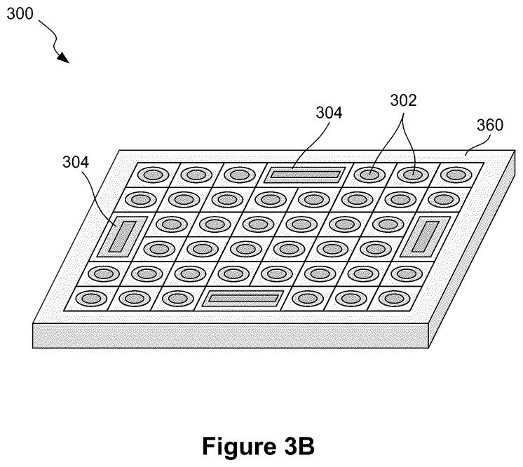

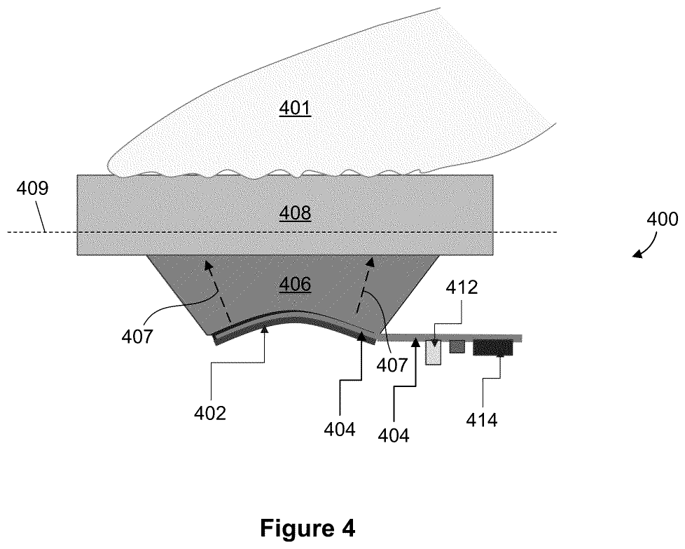

The platen 101 may be constructed such that a portion or a body part of a user (e.g., a finger) can be received by and make contact with the platen 101. In some applications, at least a portion of the platen 101 may be associated with a sensing portion or a sensing area, where acoustic (e.g., ultrasonic) sensing may occur with an object such as a portion or body part of a user (e.g., a finger). Further features of the platen 101 relating to transmission of acoustic signals and receipt of acoustic signals reflected from the portion of the user will be described with respect to platen 390 in FIG. 3A.

As will be described further below, the flexible substrate 103 (and/or other components of the apparatus 100 or the associated stack of materials) may give the apparatus 100 the capability to be curved to conform to any shape, such as the shape of the platen 101 or other desired shape. For instance, during the bending, folding, or twisting of a device implementing the apparatus 100, the apparatus 100 may also be bent, folded, or twisted. As alluded to above, the apparatus 100 may alternatively be fixed to a bent, folded, twisted, or otherwise curved surface.

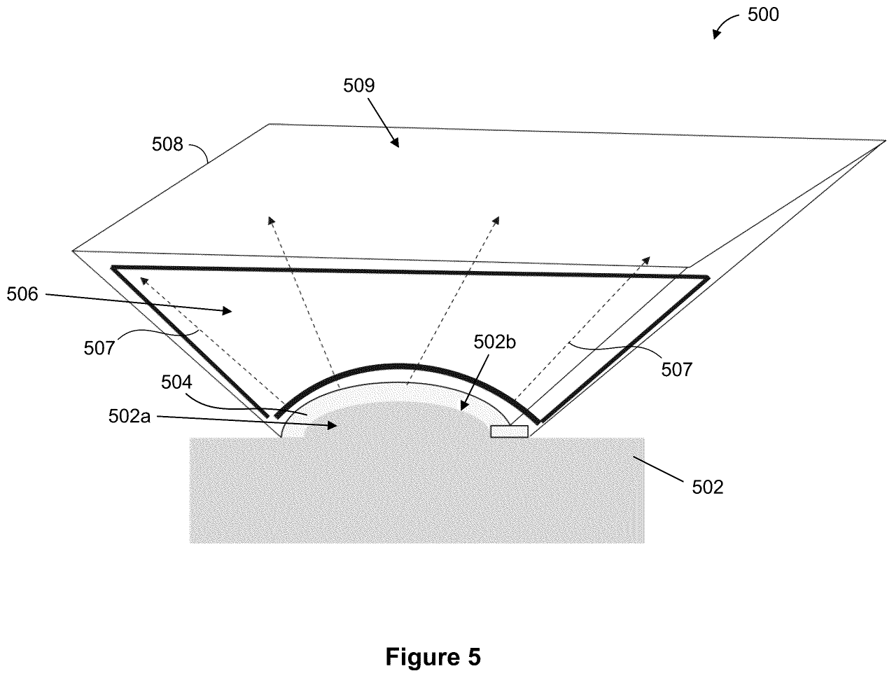

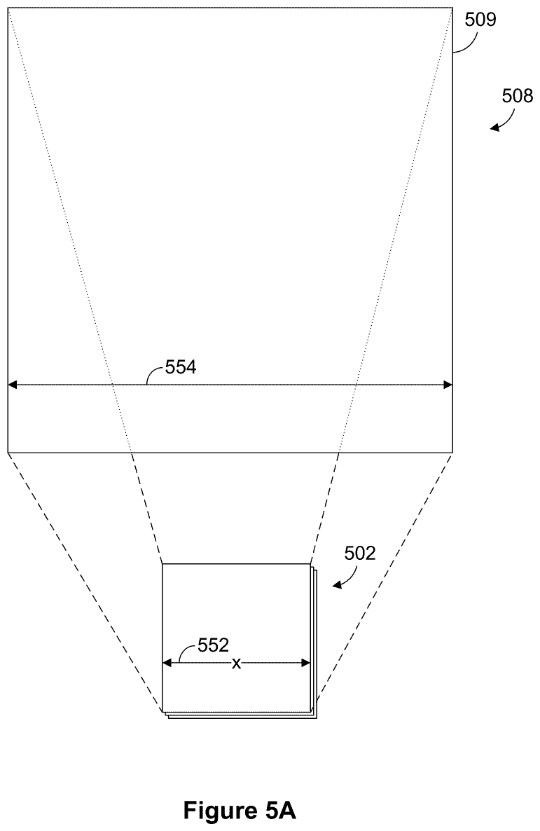

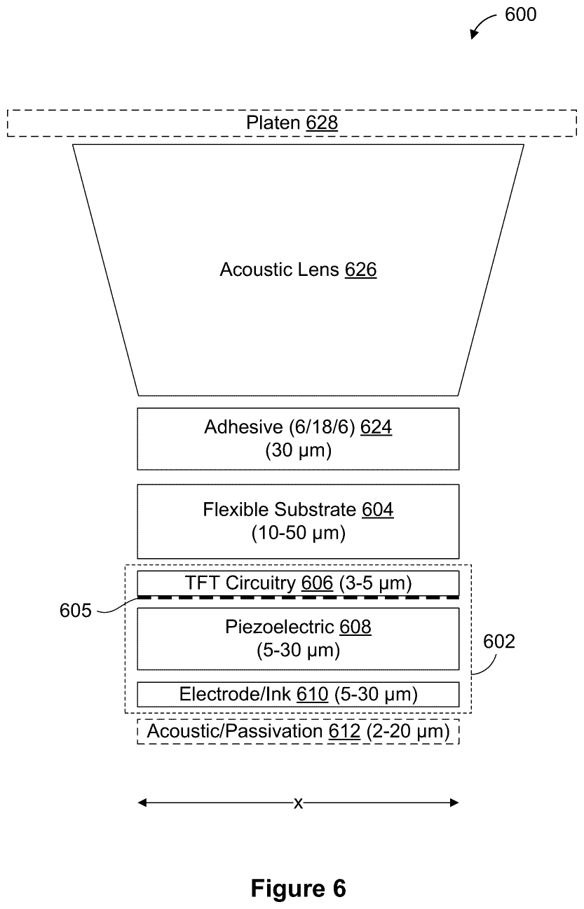

In some embodiments, the acoustic lens 102 may have a curvature to increase a range of propagation angles of acoustic waves that travel through the acoustic lens 102, e.g., from an acoustic transmitter system 104. The lens effect may cause acoustic waves to propagate outward spherically, rather than in parallel as with a planar sensing element. For example, at least one surface may be a curved surface, such as the surface that is disposed adjacent to a sensing element or a portion thereof, such as the flexible substrate 103. As another example, one side of the acoustic lens 102 may be slanted and not parallel to an opposing side of the acoustic lens 102. As is illustrated in FIGS. 4 and 5, the acoustic lens 102 can have a non-uniform construction along at least one axis so as to increase the range of propagation angles.

More specifically, in some implementations, the acoustic lens 102 may be constructed of a polymer material, such as silicone rubber, polydimethylsiloxane (PDMS), or room-temperature vulcanization (RTV) silicone. Physical parameters and dimensions of the acoustic lens 102 may vary, e.g., depending on the size of the sensor and/or the device in which the acoustic lens 102 is implemented. The height and radius of the acoustic lens 102, for example, may be dependent on a dimension or size of the sensing element 120 (including acoustic transmitter system 104 and acoustic receiver system 105). The length, width, curvature, and angle, on the other hand, may depend on a dimension or size of the device (which, in some examples, may be or include apparatus 100). In some examples, a larger curvature and/or angle (e.g., of the slanted sides) with respect to a vertical axis associated with the acoustic lens 102 may be more feasible with a taller and/or wider device.

In some embodiments, the flexible substrate 103 may be disposed adjacent to the acoustic lens 102. In some implementations, the flexible substrate 103 and a sensing element (e.g., acoustic transmitter system 104 and acoustic receiver system 105) may be directly laminated to a curved concave surface of the acoustic lens 102. The flexible substrate 103 can be conformed to such a curved surface (and indeed any shape) because it may be constructed of a flexible material. In some implementations, flexible substrate 103 may be constructed of a polymer such as polyimide. In other implementations, flexible substrate 103 may be constructed of polyethylene terephthalate (PET), polyethylene naphthalate (PEN), thermoplastic polyurethane (TPU), cellulose paper, polyestersulfone (PES), or colorless polyimide (CPI). In some implementations, flexible substrate 103 may be constructed of stainless steel.

In some implementations, the flexible substrate 103 may have a thickness of 10 to 50 microns (μm). Depending on the use case or application, the flexible substrate 103 may have a thickness that is lower or higher than the foregoing range, or on the lower end or the higher end of the foregoing range, to support the desired amount of flexibility. As an illustrative consideration, the flexible substrate 103 may be closer to 10-20 μm thick if more flexibility is desired, e.g., where the apparatus 100 is used with a highly curved surface, or used with a device that folds frequently such as a foldable display. On the other hand, the flexible substrate 103 may be closer to 40-50 μm thick if less flexibility is needed, e.g., where the apparatus 100 is disposed at a substantially planar surface with little curvature. In the case of stainless steel, the thickness may be thinner, e.g., 10-25 μm.

Various configurations of an acoustic transmitter system 104 and an acoustic receiver system 105 are also disclosed herein. Specific examples are described in more detail below.

In some embodiments, the acoustic transmitter system 104 may be configured to generate and emit acoustic signals, e.g., toward a target object, such as a finger or other object. Acoustic signals may include one or more acoustic waves, such as, in some scenarios, ultrasonic waves 364 as shown in FIG. 3A. In some implementations, the acoustic transmitter system 104 may include one or more ultrasonic transmitters or transmitter elements configured to generate, emit, and/or direct ultrasonic waves. The one or more ultrasonic transmitters may be one or more ultrasonic transducers. In some implementations, ultrasonic waves may be generated in a selected portion of multiple ultrasound transmitter elements (e.g., in an array). In some configurations, the one or more ultrasonic transmitter elements may be arranged in an array of ultrasonic transducer elements, such as an array of PMUTs and/or an array of CMUTs. In some examples, the ultrasonic transmitter(s) may include an ultrasonic plane-wave generator.

In some implementations, a control system 106 may include one or more controllers or processors, or a drive circuit or various types of drive circuitry, configured to control the one or more ultrasonic transmitter elements via one or more instructions to the acoustic transmitter system 104. For example, ultrasonic waves may be generated in pulses (e.g., at least partly repeating or other patterns) or according to other timing instructions. Although “ultrasound” may typically apply to acoustic energy with a frequency above human hearing, or 20 kilohertz (kHz), ultrasound frequencies used for fingerprint imaging may exceed well over this lower limit. In some implementations, the control system 106 may cause ultrasonic waves from the acoustic transmitter system 104 to be generated and emitted at a frequency that is between about 12 megahertz (MHz) to 50 MHz, which may result in sufficient resolution for fingerprint imaging, e.g., up to 1000 dots per inch (dpi). Other suitable frequencies may be used for the acoustic waves in other implementations.

Control system 106 may be electrically and/or communicatively coupled to the apparatus 100. In some configurations, the control system 106 may be part of the apparatus 100. In some configurations, the control system 106 may be part of a device having the apparatus 100. In some configurations, the control system 106 may be external to the apparatus 100 or the device having the apparatus 100, for example but not limited to, on a server (cloud), remote storage, or another device other than the device having the apparatus 100. In some configurations, the one or more controllers or processors of the control system 106 may be distributed across two or more devices including external apparatus.

In some implementations, the control system 106 may include one or more general purpose single- or multi-chip processors, digital signal processors (DSPs), application-specific integrated circuits (ASICs), field programmable gate arrays (FPGAs) or other programmable logic devices, discrete gates or transistor logic, discrete hardware components, or combinations thereof. The control system 106 also may include (and/or be configured for communication with) one or more memory devices, such as one or more random access memory (RAM) devices, read-only memory (ROM) devices, etc. Accordingly, the apparatus 100 may have a memory system that includes one or more memory devices, though the memory system is not shown in FIG. 1. In some implementations, functionality of the control system 106 may be partitioned between one or more controllers or processors, such as a dedicated sensor controller and an applications processor of a mobile device.

If the apparatus 100 includes an ultrasonic transmitter, such as in the acoustic transmitter system 104, the control system 106 may be configured for controlling the ultrasonic transmitter. In some embodiments, a control system 106 may cause the acoustic transmitter system 104 to generate and emit acoustic waves. In some implementations, the control system 106 may cause the acoustic transmitter system 104 to generate and emit acoustic waves in response to a detection of an object (e.g., a finger). In some cases, the object may be detected based at least on a force applied to the apparatus 100. Sensor elements 304 may be used for non-ultrasonic force detection, for example. In another example, a resistive sensor or capacitive sensing with a touchscreen may allow detection of sufficient force applied to the apparatus 100.

In some cases, the object may be detected based at least on light occlusion. In such cases, a light sensor may also be included with the apparatus 100 so that an amount of light or its absence (e.g., relative to a threshold) can be determined, e.g., by control system 106, at or near the apparatus 100.

In some cases, the object may be detected based at least on a capacitive shift or response. For example, a capacitive sensor or touchscreen may allow determination of a capacitive response based on the natural conductivity of the object such as a finger that is making contact with the platen 101 of the apparatus 100.

In some implementations, a combination of one or more detection methods described above may be used to detect the object. For instance, detection of the object may require, in some configurations, sufficient force and sufficient capacitive response. In another example, detection of the object may require sufficient force, sufficient capacitive response, and sufficient absence of light.

In some configurations, a delay may be placed between the detection of the object and the emission of the acoustic waves, where the length of the delay may be 100 milliseconds, 500 milliseconds, etc. Not causing emission of acoustic waves immediately may allow time for the object to stabilize against the apparatus 100 before performing, e.g., fingerprint sensing. Force or occlusion may occur even if the finger is not pressed onto the apparatus 100 completely.

In some implementations, the acoustic transmitter system 104 may include one or more acoustic waveguides or ultrasonic waveguides (or other sound-directing elements) constructed to propagate and direct acoustic or ultrasonic waves toward a target location that does not have direct line of sight from at least a portion of the one or more ultrasound transmitter elements. Such waveguides may be useful in certain devices, e.g., foldable displays, or chasses that may optimize the locations of the acoustic transmitter system 104 and the location of a fingerprint sensor by placing them out of direct line of sight.

The acoustic signals (e.g., ultrasonic waves) emitted from acoustic transmitter system 104 may cause or result in reflection of acoustic wave emissions at least in part from the object (e.g., finger). As noted above, characteristics of the reflected waves such as amplitudes may depend in part on the acoustic properties of the object and/or the platen. These reflected acoustic waves (e.g., ultrasonic waves) may be detectable by the acoustic receiver system 105.

Various examples of an acoustic receiver system 105 are disclosed herein, some of which may include an ultrasonic receiver system. In some implementations, the acoustic receiver system 105 may include an ultrasonic receiver system having the one or more ultrasonic receiver elements. In some implementations, one or more ultrasonic receiver elements and one or more ultrasonic transmitter elements may be combined in an ultrasonic transceiver. In some examples, the acoustic receiver system 105 and the acoustic transmitter system 104 may both include the same piezoelectric receiver layer, such as a layer of polyvinylidene fluoride (PVDF) polymer or a layer of poly(vinylidene fluoride-co-trifluoroethylene) (PVDF-TrFE) copolymer. In some implementations, a single piezoelectric layer may serve as an ultrasonic receiver. In some implementations, other piezoelectric materials may be used in the piezoelectric layer, such as aluminum nitride (AlN) or lead zirconate titanate (PZT). According to some examples, the acoustic receiver system 105 may be, or may include, an ultrasonic receiver array. The acoustic receiver system 105 may, in some examples, include an array of ultrasonic transducer elements, such as an array of PMUTs, an array of CMUTs, etc. In some such examples, a piezoelectric receiver layer, PMUT elements in a single-layer array of PMUTs, or CMUT elements in a single-layer array of CMUTs, may be used as ultrasonic transmitters (such as those that are included in acoustic transmitter system 104) as well as ultrasonic receivers. In some examples, the apparatus 100 may include one or more separate ultrasonic transmitter elements or one or more separate arrays of ultrasonic transmitter elements. Ultrasonic sensor array 300, sensor system 202, and ultrasonic sensor array 212 may be examples or implementations of the acoustic receiver system 105.

In the context of the present disclosure, a transmitter element and a receiver element may collectively or individually be referred to as a “sensing element,” an “acoustic sensing element,” a “sensor element,” or an “acoustic sensor element.” Such an element may also refer to a transceiver element or an acoustic transceiver element. In some instances, the foregoing terms may refer collectively, for example as a sensing element 120, to a transmitter element and a receiver element that share the same piezoelectric layer.

In some other embodiments, the acoustic receiver system 105 may include one or more microphones configured to detect acoustic signals. Each microphone may be a MEMS (micro-electromechanical system) microphone having an inlet port, a cavity, and/or a membrane or mesh to facilitate detection and receipt of acoustic signals, e.g., sound waves. In some implementations, the microphone(s) may be part of another apparatus or system other than the apparatus 100, such as the interface system 108 described below.

Accordingly, embodiments of apparatus 100 may be configured to operate as ultrasound sensors that are configured to receive reflected acoustic signals such as ultrasonic waves. Reflected ultrasonic waves may include scattered waves, specularly reflected waves, or both scattered waves and specularly reflected waves. The reflected waves can provide acoustic data, including information about the object, e.g., a finger's ridges and valleys and their shapes and patterns.

More specifically, in some embodiments, control system 106 may be configured to receive the acoustic data (e.g., from acoustic receiver system 105) and/or generate images (e.g., three-dimensional images) representative of the object such as a finger. That is, fingerprint imaging may be performed using the acoustic data received by the acoustic receiver system 105. Images may be matched to a reference to identify the fingerprint image.

In some examples, the control system 106 may be communicatively coupled to a light source system (not shown) and configured to control the light source system to emit light towards a target object (such as a finger) on an outer surface of the platen 101. In some such examples, the control system 106 may be communicatively coupled to and configured to receive signals from the acoustic receiver system 105 (including one or more receiver elements, such as sensor elements 362) corresponding to the ultrasonic waves generated by the target object responsive to the light from the light source system.

In the context of fingerprint sensing, ultrasonic fingerprint sensing may advantageously be more reliable and secure (e.g., for storing user identifying information), and have a smaller and more flexible footprint, than other types of fingerprint sensing such as traditional optical fingerprint scanning that relies on optical imaging.

Some implementations of the apparatus 100 may include an interface system 108. In some examples, the interface system 108 may include a wireless interface system. In some implementations, the interface system 108 may include a user interface system, one or more network interfaces, one or more communication interfaces between the control system 106 and a memory system and/or one or more interfaces between the control system 106 and one or more external device interfaces (such as ports or applications processors), or combinations thereof. According to some examples in which the interface system 108 is present and includes a user interface system, the user interface system may include a microphone system (including, e.g., one or more microphones), a loudspeaker system, a haptic feedback system, a voice command system, one or more displays, or combinations thereof. According to some examples, the interface system 108 may include a touch sensor system, a gesture sensor system, or a combination thereof. The touch sensor system (if present) may be, or may include, a resistive touch sensor system, a surface capacitive touch sensor system, a projected capacitive touch sensor system, a surface acoustic wave touch sensor system, an infrared touch sensor system, any other suitable type of touch sensor system, or combinations thereof.

In some examples, the interface system 108 may include a force sensor system. The force sensor system (if present) may be, or may include, a piezo-resistive sensor, a capacitive sensor, a thin film sensor (for example, a polymer-based thin film sensor), another type of suitable force sensor, or combinations thereof. If the force sensor system includes a piezo-resistive sensor, the piezo-resistive sensor may include silicon, metal, polysilicon, glass, or combinations thereof. An ultrasonic fingerprint sensor and a force sensor system may, in some implementations, be mechanically coupled. In some implementations, the force sensor system may be mechanically coupled to a platen. In some such examples, the force sensor system may be integrated into circuitry of the ultrasonic fingerprint sensor. In some examples, the interface system 108 may include an optical sensor system, one or more cameras, or a combination thereof.

According to some examples, the apparatus 100 may include a noise reduction system 110. In some implementations, the noise reduction system 110 may include one or more sound-absorbing layers, acoustic isolation material, or combinations thereof. In some examples, the noise reduction system 110 may include acoustic isolation material, which may reside between at least a portion of the acoustic transmitter system 104 and at least a portion of the acoustic receiver system 105, e.g., between ultrasonic transmitter elements and ultrasonic receiver elements. In some examples, the noise reduction system 110 may include one or more electromagnetically shielded transmission wires. In some such examples, the one or more electromagnetically shielded transmission wires may be configured to reduce electromagnetic interference from circuitry of the acoustic transmitter system 104, circuitry of the acoustic receiver system 105, or combinations thereof, that is received by the acoustic receiver system 105.

In some implementations, the apparatus 100 may be part of a mobile device. In some implementations, the apparatus 100 may be part of a wearable device configured to be worn by a user, such as around the wrist, finger, arm, leg, ankle, or another appendage, or another portion of the body. In an example implementation, the wearable device may have the form of a wristwatch and can be worn around the wrist.

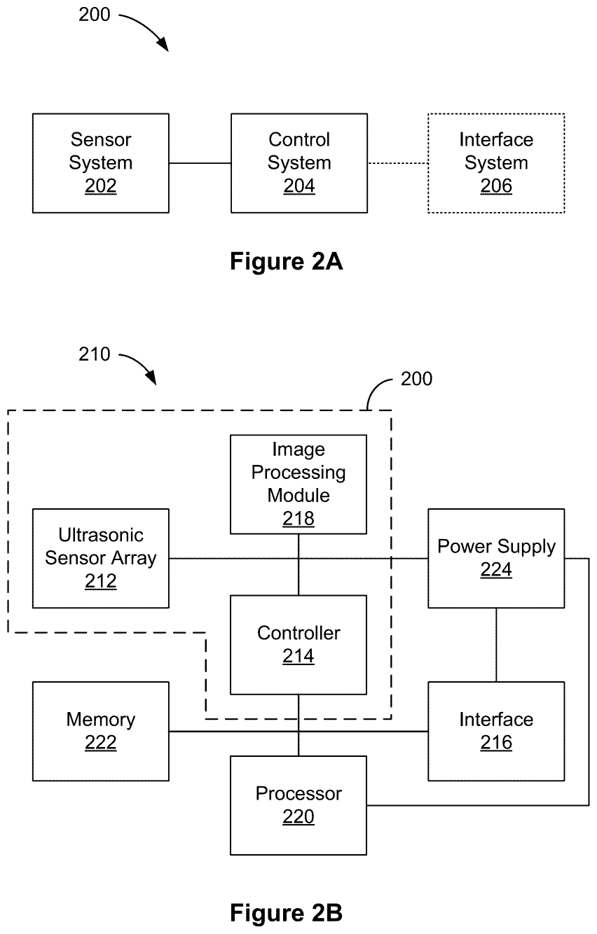

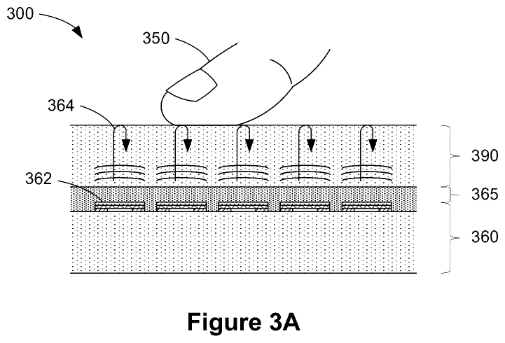

An ultrasonic sensor array may be part of a sensing system of a device, for example, apparatus 100 implemented with a mobile device. FIG. 2A shows a block diagram representation of components of an example sensing system 200. As shown, the sensing system 200 may include a sensor system 202 and a control system 204 that may, in some implementations, be electrically and/or communicatively coupled to the sensor system 202. In some implementations, control system 204 may include one or more controllers or processors. Control system 204 may be an example of control system 106. In some configurations, the control system 204 may be part of the device having the sensing system. In some configurations, the control system 204 may be part of the sensing system. In some configurations, the control system 204 may be external to the device having the sensing system, for example but not limited to, on a server (cloud), remote storage, or another device other than the device having the sensing system. In some configurations, the one or more controllers or processors may be distributed across two or more devices including external apparatus.

The sensor system 202 (e.g., in conjunction with control system 204, in some implementations) may be capable of detecting the presence of an object, for example a human finger. The sensor system 202 may be capable of scanning an object and providing raw measured image information usable to obtain an object signature, for example, a fingerprint of a human finger (such as 350). The control system 204 may be capable of controlling the sensor system 202 and processing the raw measured image information received from the sensor system. In some implementations, the sensing system 200 may include an interface system 206 capable of transmitting or receiving data, such as raw or processed measured image information, to or from various components within or integrated with the sensing system 200 or, in some implementations, to or from various components, devices or other systems external to the sensing system.

FIG. 2B shows a block diagram representation of components of an example mobile device 210 that includes the sensing system 200 of FIG. 2A. The sensor system 202 of the sensing system 200 of the mobile device 210 may be implemented with an ultrasonic sensor array 212, such as the ultrasonic sensor array 300 shown in FIG. 3B. The control system 204 of the sensing system 200 may be implemented with a controller 214 that is electrically coupled to the ultrasonic sensor array 212. While the controller 214 is shown and described as a single component, in some implementations, the controller 214 may collectively refer to two or more distinct control units or processing units in electrical communication with one another. In some implementations, the controller 214 may include one or more of a general purpose single- or multi-chip processor, a central processing unit (CPU), a digital signal processor (DSP), an applications processor, an application specific integrated circuit (ASIC), a field programmable gate array (FPGA) or other programmable logic device (PLD), discrete gate or transistor logic, discrete hardware components, or any combination thereof designed to perform the functions and operations described herein.

The sensing system 200 of FIG. 2B may include an image processing module 218. In some implementations, raw measured image information provided by the ultrasonic sensor array 212 may be sent, transmitted, communicated or otherwise provided to the image processing module 218. The image processing module 218 may include any suitable combination of hardware, firmware and software configured, adapted or otherwise operable to process the image information provided by the ultrasonic sensor array 212. In some implementations, the image processing module 218 may include signal or image processing circuits or circuit components including, for example, amplifiers (such as instrumentation amplifiers or buffer amplifiers), analog or digital mixers or multipliers, switches, analog-to-digital converters (ADCs), passive or active analog filters, among others. In some implementations, one or more of such circuits or circuit components may be integrated within the controller 214, for example, where the controller 214 is implemented as a system-on-chip (SoC) or a system-in-package (SIP). In some implementations, one or more of such circuits or circuit components may be integrated within a DSP included within or coupled to the controller 214. In some implementations, the image processing module 218 may be implemented at least partially via software. For example, one or more functions of, or operations performed by, one or more of the circuits or circuit components just described may instead be performed by one or more software modules executing, for example, in a processing unit of the controller 214 (such as in a general purpose processor or a DSP).

In some implementations, in addition to the sensing system 200, the mobile device 210 may include a separate processor 220 such as an applications processor, a memory 222, an interface 216 and a power supply 224. In some implementations, the controller 214 of the sensing system 200 may control the ultrasonic sensor array 212 and the image processing module 218, and the processor 220 of the mobile device 210 may control other components of the mobile device 210. In some implementations, the processor 220 may communicate data to the controller 214 including, for example, instructions or commands. In some such implementations, the controller 214 may communicate data to the processor 220 including, for example, raw or processed image information. It should also be understood that, in some other implementations, the functionality of the controller 214 may be implemented entirely, or at least partially, by the processor 220. In some such implementations, a separate controller 214 for the sensing system 200 may not be required because the functions of the controller 214 may be performed by the processor 220 of the mobile device 210.

Depending on the implementation, one or both of the controller 214 and processor 220 may store data in the memory 222. For example, the data stored in the memory 222 may include raw measured image information, filtered or otherwise processed image information, estimated PSF or estimated image information, and final refined PSF or final refined image information. The memory 222 may store processor-executable code or other executable computer-readable instructions capable of execution by one or both of the controller 214 and the processor 220 to perform various operations (or to cause other components such as the ultrasonic sensor array 212, the image processing module 218, or other modules to perform operations), including any of the calculations, computations, estimations or other determinations described herein (including those presented in any of the equations below). It should also be understood that the memory 222 may collectively refer to one or more memory devices (or “components”). For example, depending on the implementation, the controller 214 may have access to and store data in a different memory device than the processor 220. In some implementations, one or more of the memory components may be implemented as a NOR- or NAND-based Flash memory array. In some other implementations, one or more of the memory components may be implemented as a different type of non-volatile memory. Additionally, in some implementations, one or more of the memory components may include a volatile memory array such as, for example, a type of RAM.

In some implementations, the controller 214 or the processor 220 may communicate data stored in the memory 222 or data received directly from the image processing module 218 through an interface 216. For example, such communicated data can include image information or data derived or otherwise determined from image information. The interface 216 may collectively refer to one or more interfaces of one or more various types. In some implementations, the interface 216 may include a memory interface for receiving data from or storing data to an external memory such as a removable memory device. Additionally or alternatively, the interface 216 may include one or more wireless network interfaces or one or more wired network interfaces enabling the transfer of raw or processed data to, as well as the reception of data from, an external computing device, system or server.

A power supply 224 may provide power to some or all of the components in the mobile device 210. The power supply 224 may include one or more of a variety of energy storage devices. For example, the power supply 224 may include a rechargeable battery, such as a nickel-cadmium battery or a lithium-ion battery. Additionally or alternatively, the power supply 224 may include one or more supercapacitors. In some implementations, the power supply 224 may be chargeable (or “rechargeable”) using power accessed from, for example, a wall socket (or “outlet”) or a photovoltaic device (or “solar cell” or “solar cell array”) integrated with the mobile device 210. Additionally or alternatively, the power supply 224 may be wirelessly chargeable.

As used herein, the term “processing unit” refers to any combination of one or more of a controller of an ultrasonic system (for example, the controller 214), an image processing module (for example, the image processing module 218), or a separate processor of a device that includes the ultrasonic system (for example, the processor 220). In other words, operations that are described below as being performed by or using a processing unit may be performed by one or more of a controller of the ultrasonic system, an image processing module, or a separate processor of a device that includes the sensing system.

FIG. 3A illustrates a side view of an example configuration of an ultrasonic sensor array of sensor elements which is capable of ultrasonic imaging. FIG. 3A depicts an ultrasonic sensor array 300 with an array of sensor elements configured as transmitting and receiving elements that may be used for ultrasonic imaging. In some implementations, the ultrasonic sensor array 300 may be an example of or a portion of a sensor element or a sensor as discussed herein.

Sensor elements 362 on a sensor array substrate 360 may emit and detect ultrasonic waves. In some implementations, sensor array substrate 360 may be an example of the flexible substrate 103 discussed above, and may thus be flexible (e.g., foldable). As illustrated, an ultrasonic wave 364 may be transmitted from at one or more sensor elements 362. The ultrasonic wave 364 may travel through a propagation medium such as an acoustic coupling medium 365 and a platen 390 towards an object 350 such as a finger or a stylus positioned on an outer surface of the platen 390. Platen 390 may be an example of platen 101, and may thus be flexible (e.g., foldable). A portion of the ultrasonic wave 364 may be transmitted through the platen 390 and into the object 350, while a second portion is reflected from the surface of platen 390 back towards a sensor element 362. The amplitude of the reflected wave may depend in part on the acoustic properties of the object 350 and the platen 390. The reflected wave may be detected by the sensor elements 362, from which an image of the object 350 may be acquired. For example, with sensor arrays having a pitch of about 50 microns (about 500 pixels per inch), ridges and valleys of a fingerprint may be detected. In some implementations, an acoustic lens (not shown), such as acoustic lens 102 or of the type that will be discussed in further detail below, may be disposed between the platen 390 and the sensor array substrate 360. An acoustic coupling medium 365, such as an adhesive, gel, a compliant layer or other acoustic coupling material may be provided to improve coupling between an array of sensor elements 362 disposed on the sensor array substrate 360 and the platen 390. The acoustic coupling medium 365 may aid in the transmission of ultrasonic waves to and from the sensor elements 362. The platen 390 may include, for example, a layer of glass, plastic, sapphire, metal, metal alloy, or other platen material. An acoustic impedance matching layer (not shown) may be disposed on an outer surface of the platen 390. The platen 390 may include a coating (not shown) on the outer surface. In some implementations, sensor elements may be co-fabricated with thin-film transistor (TFT) circuitry or CMOS circuitry on or in the same substrate, which may be a silicon, silicon on insulator (SOI), glass or plastic substrate, in some examples. The TFT, silicon or semiconductor substrate may include row and column addressing electronics, multiplexers, local amplification stages and control circuitry.

FIG. 3B shows an example configuration of an ultrasonic sensor array including sensor elements 302 and sensor elements 304 formed on a substrate 360. Substrate 360 may be an example of the sensor array substrate 360 mentioned above. The sensor elements 302 are shown as circular sensor elements. In some implementations, the sensor elements 302 are not used for force detection in the non-ultrasonic force detection mode. Sensor elements 304 are larger than the sensor elements 302 and are shown as rectangular. It will be understood that these sensor elements 302, 304 may be any appropriate shape and size. In some implementations, the sensor elements 304 that are used for non-ultrasonic force detection may be larger than the sensor elements 302 that are used solely for ultrasonic imaging. The sensor elements 304, used during non-ultrasonic force detection mode to detect applied force as described above, are located on the periphery of the ultrasonic sensor array 300. By placing the sensor elements 304 used for force detection around the periphery, the ultrasonic sensor array may be used for centering detection. While only the sensor elements 304 are used for non-ultrasonic force detection, both sensor elements 302 and sensor elements 304 may be used for ultrasonic imaging as described above with respect to FIG. 3A. That is, the sensor elements 304 may initially be used to statically detect force from a finger press and then be switched to an ultrasonic mode for ultrasonic imaging in some implementations. In alternative implementations, the sensor elements 304 may be used only for force detection, with only the sensor elements 302 used for ultrasonic imaging. In some implementations, sensor elements 304 near the periphery of the ultrasonic sensor array 300 may be used for cursor, pointer or icon control, or for screen navigation on a display of a mobile device. In some implementations, some or all of sensor elements 302, 304, 362 in FIGS. 3A and 3B may be piezoelectric micromachined ultrasonic transducers (PMUT) and/or capacitive micromachined ultrasonic transducers (CMUT) sensor elements.

### Example Flexible Substrate With Acoustic Lens

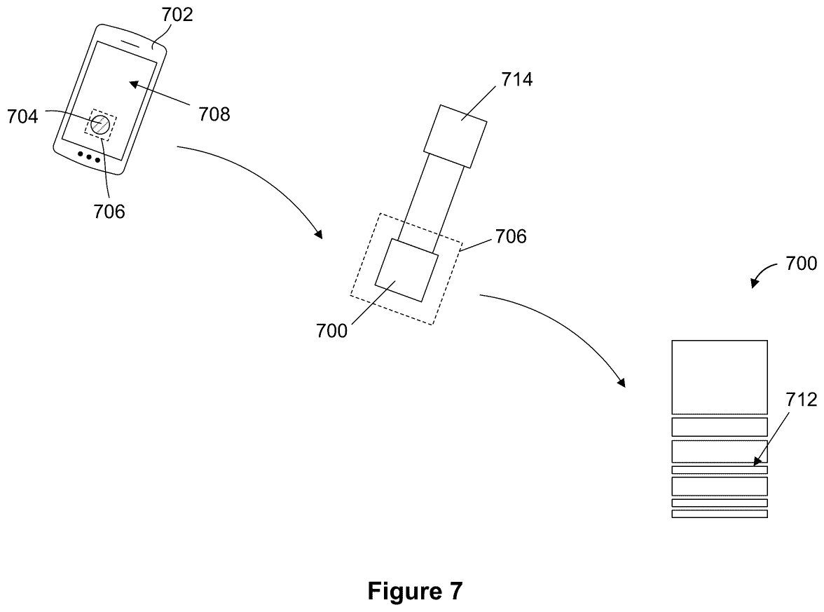

FIG. 4 is a cross-sectional diagram of a flexible acoustic sensor system 400 using an acoustic lens 406, according to some embodiments. In some embodiments, the acoustic sensor system 400 may include a sensing element 402, a substrate 404, an acoustic lens 406, and a platen 408. As noted earlier, a “sensing element” may refer collectively to a transmitter element and a receiver element. In some implementations, the sensing element may be a fingerprint sensor or a part thereof. Hence, in some embodiments, the sensing element 402 may thus include an acoustic transmitter element and an acoustic receiver element, discussed further with respect to the example stack of material shown in FIG. 6. The acoustic lens 406 may be an example of acoustic lens 102.

In some embodiments, the sensing element 402 may be a flexible sensor. The sensing element 402 may be configured to transmit one or more acoustic signals (e.g., ultrasonic waves) toward the platen 408 and/or a target object 401 (e.g., a body part of a user, such as a finger) based on a transmit signal applied to the acoustic transmitter element, and receive and detect one or more acoustic signals reflected from the target object 401. The sensing element 402 may have a sensing portion associated therewith, e.g., at a surface of an acoustic transmitter element and/or an acoustic receiver element (or an array thereof) of the sensing element 402.

In some implementations, the sensing element 402 may be disposed adjacent to other components such as a flexible substrate, e.g., the substrate 404. In some configurations, by virtue of the flexibility possessed by the sensing element 402, at least portions of the sensing element 402, as well as the substrate 404, may deform and conform to a curved surface.

In some embodiments, the substrate 404 may be constructed of a flexible material and thus may be a flexible substrate, which may be an example of flexible substrate 103. In some implementations, the substrate 404 may comprise polyimide. In some implementations, the substrate 404 may comprise another polymer, such as those listed above. As depicted in FIG. 4, the substrate 404 may conform to a curved surface of the acoustic lens 406. Similarly, the sensing element 402 may conform to the curved surface of the acoustic lens 406. In some cases, the flexible sensing element 402 may be directly laminated and secured to the curved surface of the acoustic lens 406 via the substrate 404. In some implementations, lamination may be achieved using adhesives or an adhesive tape or layer, e.g., a pressure-sensitive adhesive (PSA), an optically clear adhesive (OCA). That is, an adhesive layer may be used between the acoustic lens 406 and the substrate 404.

In some configurations, the substrate 404 may also include passive components 412, a control system 414 (e.g., control circuitry such as ASIC, a processor apparatus having one or more processors), and/or other components. These components may be electrically and/or communicatively coupled with at least the sensing element 402, enabling signal and/or data communication between the sensing element 402 and the components. For example, a transmit signal may be sent from the control system 414 to the sensing element 402 (e.g., to an acoustic transmitter element), and a receive signal from the sensing element 402 (e.g., from an acoustic receiver element) may be received at the control system 414.

In some embodiments, the acoustic lens 406 may have a curvature and/or other parameters configured to shift or alter the propagation angle and range for acoustic signals. As shown, at least one curved surface may be present, proximate to the sensing element 402 and the substrate 404. The acoustic lens 406 may also have slanted surfaces, shown on the left and the right side as depicted in FIG. 4.

In some embodiments, the acoustic lens 406 may be constructed of a polymer material, such as silicone rubber, PDMS, or RTV silicone.

In some embodiments, the acoustic lens 406 may be disposed adjacent or physically coupled or attached to the platen 408. Platen 408 may be an example of platen 101, and may thus be flexible as well.

Acoustic signals (e.g., acoustic wave 407) generated from the sensing element 402 may travel spherically (or normally to the surface of the curvature of the sensing element 402) rather than in parallel, as illustrated in FIG. 4. As an acoustic wave 407 travels through the acoustic lens 406 after being generated from the sensing element 402, the acoustic wave 407 may not travel orthogonally to a plane 409 of the platen 408. Rather, the acoustic wave 407 may expand outward as a result of the lens effect, at an increased propagation angle range, as it travels toward the platen 408 and/or the target object 401. Reflected acoustic waves may be collected by the sensing element 402 along the same paths as those taken by the transmitted acoustic waves 407. That is, while the propagation angle range is expanded during transmission, the propagation angle range is narrowed when receiving the acoustic signals.

Advantageously, this expansion of the propagation angle range allows the acoustic sensor system 400 (e.g., at the sensing element 402) to acoustically image a larger object or a larger area than the size of the sensing element 402. That is, an area associated with the imaging portion of the platen 408 may be larger than an area associated with the sensing element 402 (e.g., an area of the sensing portion), as will be detailed in FIGS. 5 and 5A.

FIG. 5 is a diagram of a flexible acoustic sensor system 500 using an acoustic lens 506, according to some embodiments. In some implementations, flexible acoustic sensor system 500 may be an example of flexible acoustic sensor system 400.

In some embodiments, the acoustic sensor system 500 may include a sensing element 502, a substrate 504, an acoustic lens 506, and a platen 508. The sensing element 502 may be an example of the sensing element 402. The substrate 504 may be an example of the substrate 404. The acoustic lens 506 may be an example of the acoustic lens 406. The platen 508 may be an example of the platen 408.

In some implementations, the sensing element 502 may be disposed adjacent to other components such as a flexible substrate, e.g., substrate 504. In some configurations, by virtue of the flexibility possessed by the sensing element 502, at least a portion 502a of the sensing element 502, as well as the substrate 504, may deform and conform to a curved surface of the acoustic lens 506.

In some embodiments, the acoustic lens 506 may have a curvature and/or parameters configured to alter the propagation angles and range for acoustic signals 507. In some embodiments, acoustic lens 506 be constructed of a polymer material, such as silicone rubber, PDMS, or RTV silicone.

Acoustic signals 507 generated from the sensing element 502 may travel spherically (or normally to the surface of the curvature of the sensing element 502) as illustrated in FIG. 5. Reflected acoustic waves may be collected by the sensing element 502 along the same paths as those taken by the transmitted acoustic signals 507. As a result, a larger area may be captured with a smaller sensing element 502. More specifically, an area associated with the imaging portion 509 associated with a surface of the platen 508 may be larger than an area of a sensing portion 502b associated with (a surface of) the sensing element 502.

FIG. 5A illustrates a comparison of an area associated with a sensing element (e.g., sensing element 502 of FIG. 5) and an area associated with an imaging portion 509 at a surface of a platen (e.g., platen 508 of FIG. 5), according to some examples.

In the illustrated example, the sensing element 502 may have a surface associated with a sensing portion. The surface of the sensing portion may refer to a surface of an acoustic transmitter element and/or an acoustic receiver element or an array thereof, or the top surface of a stack of materials for the sensing element 502 (closest to the acoustic lens (not shown) but not curved) and may have a width 552 of x (also as indicated in FIG. 6). For simplicity of determining the area, it will be assumed that the surface associated with a sensing portion is a square (e.g., an array of receiver pixels), and the area associated with the sensing element 502 is x². However, the surface associated with the sensing portion or the sensing element 502 may be rectangular in other implementations, or in any other shape.

Acoustic waves traveling through an acoustic lens may be directed in an expanded propagation angle range (e.g., spherically rather than in parallel) such that they reflect from an object of interest (e.g., a body part of a user such as a finger) over a larger area. In an illustrated example, a width 554 of the imaging portion 509 (e.g., at a surface of the platen 508) may be 3x, so the area associated with the imaging portion 509 may be 9x², or 9 times that of the area x² associated with the sensing element 502 (e.g., area associated with the sensing portion 502b). Depending on the parameters of the acoustic lens, the difference between the areas may be different. As non-limiting examples, the area of the imaging portion 509 may instead be 25x² or 16x² or 5x² or 2x² or 1.5x².

Advantageously, usage of an acoustic lens may enable the area associated with sensing element 502 to be smaller than conventional sensors. For instance, a typical sensor may have a width of 1.5x or 2x (or more) rather than x. The sensing element 502 according to the present disclosure may be smaller and denser (e.g., same or more receiver elements in a smaller area) than typical since the acoustic lens expands the propagation angle range and allows the same or larger imaging area, with a smaller footprint by the sensing element 502. As such, a larger imaging area can be achieved with a smaller sensor area, enabled by the acoustic lens.

As illustrative example values for the areas, the sensing area of the sensing portion 502b at the sensing element 502 may be in the millimeter range (e.g., 8 mm by 8 mm, or 25 mm by 25 mm, or 20 mm by 30 mm), and may include pixels that are, for example, 25 μm across (or a different size, e.g., 15 or 20 μm), whereas the imaging arca of the imaging portion 509 may have pixels that are, for example, five times larger at 125 μm across, potentially leading to a magnitude of order increase in the area. In this example, an example 20×20 mm² sensing portion 502b having 25 μm pixels may be expanded to a 100×100 mm² imaging portion 509 having 125 μm pixels, resulting in a 25-fold increase in the imaging area (10000 mm² vs. 400 mm²). It is noted that the sensing and imaging areas may not be wholly planar (nor square in some cases) since the acoustic lens has a curvature and a curved surface. As such, the widths and areas may be approximate. However, it is recognized that a significant increase in the imaging area and/or reduction in sensing area and the sensing element 502 (while obtaining the same imaging area as without the acoustic lens) may be achieved.

### Example Sensor Stack

FIG. 6 is a cross-sectional diagram of an example stack of materials 600 usable with embodiments of the flexible acoustic sensor system disclosed herein. The example stack of materials 600 may include a sensor element 602. The sensor element 602 may be an example of the sensing element 502 or the sensing element 402. Although each layer of the example stack of materials 600 is depicted as separate from one another, they are in direct contact with adjacent layer(s). In some cases, for example, a layer or component may be attached (e.g., laminated via an adhesive) to another layer or component, formed on a layer, or abut against another layer.

In some embodiments, sensor element 602 may include a flexible substrate 604, thin-film transistor (TFT) circuitry 606, a piezoelectric layer 608, and an electrode layer 610. Some implementations of the sensor element 602 may also include a passivation layer 612. In some cases, the sensor element 602 may refer to the foregoing components without the flexible substrate 604 (e.g., when discussing the flexible substrate separately from the sensor element or sensing portion, as in FIGS. 4, 5 and 5A).

The flexible substrate 604 may be an example of substrate 404 or substrate 504. In some implementations, the flexible substrate 604 may be constructed of a polymer such as polyimide. In other implementations, the flexible substrate 604 may be constructed of another material, such as those listed above.

In some embodiments, thin-film transistors may be grown on the flexible substrate 604 (e.g., deposited by film deposition) and thereby form TFT circuitry 606. TFT circuitry 606 may include one or more discrete (or pixelated) portions that form at least part of corresponding one or more acoustic receiver elements (represented by one or more receiver pixels 605 having TFT circuitry 606), in conjunction with the piezoelectric layer 608. In some examples, the layer of TFT circuitry 606 may be about 3-5 μm thick. The piezoelectric layer 608 in some implementations may include a PVDF or PVDF-TrFE copolymer. In some implementations, the piezoelectric layer 608 may include lead magnesium niobate/lead titanate (PMN-PT), lithium niobate (LiNbO₃), or a combination thereof. In some implementations, the piezoelectric layer 608 may be a multilayer piezoelectric structure, or an array of such structures. In some examples, the piezoelectric layer 608 may be about 5-30 μm thick.

As the acoustic waves (e.g., reflected from an object of interest) is received at the piezoelectric layer 608, the piezoelectric layer 608 can convert mechanical energy induced by the acoustic waves into electrical signals. The electrical signals may be received and processed by the directly adjacent TFT circuitry 606, or more specifically at the aforementioned one or more pixelated portions, e.g., the one or more receiver pixels 605 having TFT circuitry 606. The TFT circuitry 606 may be electrically and/or communicatively coupled with control circuitry (e.g., ASIC), a processing apparatus (e.g., having one or more processors), or other control system (e.g., control system 106) which may be configured to process the electrical signals. In some examples, fingerprint sensor signals corresponding to reflected acoustic (e.g., ultrasonic) waves from the target object may be received. In some cases, imaging data (e.g., fingerprint imaging data) and/or an image based on the imaging data (e.g., fingerprint image) may be generated. Hence, the TFT circuitry 606 may include one or more pixelated receiver electrodes that may be configured to receive acoustic (e.g., ultrasonic) signals and function as corresponding one or more acoustic receiver elements.

In some embodiments, the electrode layer 610 may include silver (Ag), e.g., in the form of conductive ink applied to the piezoelectric layer 608. In some embodiments, the electrode layer 610 may include a thin metallic layer. In some implementations, the thin metallic layer may be composed of copper (Cu), which would be pliable enough to allow the sensor element 602 conform to curved surfaces. In some examples, the electrode layer 610 (whether it is, e.g., Ag or Cu) may be about 5-30 μm thick. In implementations in which a thicker Ag is used, Ag may be applied (e.g., printed) multiple times.

Control circuitry and/or processing apparatus may drive transmit signals to the electrode layer 610, which may in turn cause generation and emission of acoustic waves from the electrode layer 610. In some examples, the control system may be configured to provide a voltage (e.g., 100-200 V, such as 120 V) to the electrode layer 610 (e.g., via a resonating circuit in passive components 412), the voltage causing the electrode layer 610 to generate the one or more acoustic signals at a frequency (e.g., 1-25 MHz, such as 7, 8, 10, 12 or 15 MHz). In general, higher frequency can provide a better resolution but sacrifice on transmission (higher decibel (dB) loss). A balance may be struck when selecting the frequency. Hence, the electrode layer 610 may be configured to emit acoustic (e.g., ultrasonic) signals and function as an acoustic transmitter element.

In some implementations, an acoustic and/or passivation layer 612 may be included with the sensor element 602. In some examples, the acoustic and/or passivation layer 612 may be about 2-20 μm thick. In some cases, a layer of polymer (e.g., polyimide, acrylic) may be provided. In some cases, passivation may include a protective coating (e.g., a non-conductive ink) applied to the sensor element 602 (or a portion thereof, such as the electrode layer 610) to make the sensor element or a surface thereof less susceptible to damage (e.g., chemical reactivity, corrosion) and increase electrical stability. The ink may also affect the resonance frequency of the resonating circuit. In some cases, passivation layer 612 may include a polymer layer, such as an acrylic or other die-attached film (DAF).

In some embodiments, sensor element 602 may be disposed adjacent to an acoustic lens 626, which may be an example of the acoustic lens 102, acoustic lens 406, or acoustic lens 506. In some cases, the sensor element 602 may be directly laminated to the acoustic lens 626, e.g., via an adhesive layer 624. In some implementations, the adhesive layer 624 may be a double-sided adhesive that includes a first layer of a pressure-sensitive adhesive (PSA), a layer of copper (Cu), and a second layer of PSA. In some examples, each of the PSA layers may be about 6 μm thick, and the Cu layer may be about 18 μm thick. Thus, the adhesive layer 624 may be about 30 μm thick.

As discussed with respect to FIGS. 4 and 5, the acoustic lens 626 may be disposed adjacent or physically coupled or attached to a platen 628, where acoustic (e.g., ultrasonic) signals transmitted from the sensor element 602 (e.g., generated by the electrode layer 610 and emitted from the boundary between the piezoelectric layer 608 and the electrode layer 610) may travel in an expanded propagation angle range. Platen 628 may be an example of platen 101, platen 408 or platen 508. One or more acoustic (e.g., ultrasonic) signals reflected from an object of interest (e.g., a finger) may then be received by the sensor element 602 (e.g., at the one or more acoustic receiver elements represented by one or more receiver pixels 605 of the TFT circuitry 606).

As such, the sensor element 602 includes layers of flexible materials. By virtue of the flexibility of the flexible substrate 604 and the sensor element 602, the example stack of materials 600 can be used with various flexible devices (e.g., foldable devices and displays) and various types of surfaces, including curved surfaces.

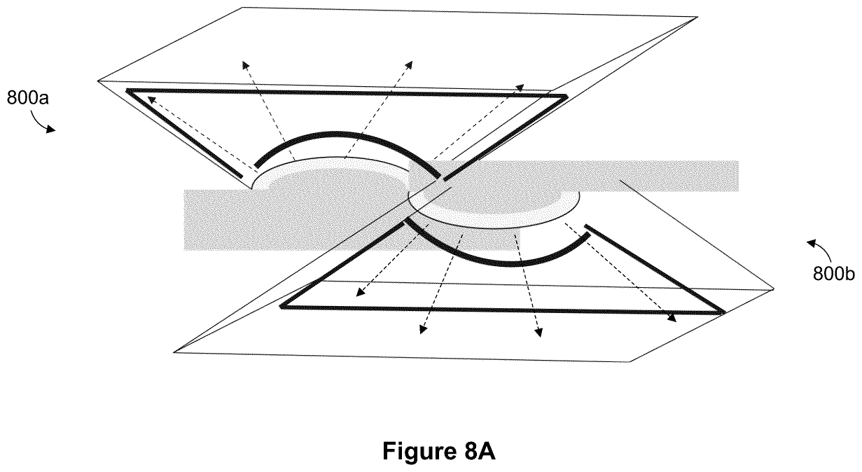

FIG. 7 shows an example implementation of a sensor stack 700 in a device 702. In some examples, the device 702 (e.g., a smartphone or other mobile device) may include an imaging portion 706 of a platen 708 (e.g., touchscreen display), where the location of a sensing portion 712 corresponds to a location of a sensor stack 700 (e.g., example stack of materials 600) underneath the platen 708. As an illustrative example, a user may press an object (e.g., finger) onto a sensing area 704 within the imaging portion 706. Based on a detection of the object (e.g., using non-ultrasonic force detection using sensor elements 304, a resistive sensor, capacitive sensing with a touchscreen, or another detection method), the device 702 may initiate a sensing operation with the sensor stack 700. That is, the sensor stack 700 may emit one or more acoustic (e.g., ultrasonic) signals through an acoustic lens (not shown) toward the object, and detect one or more reflected acoustic (e.g., ultrasonic) signals from the object. Received acoustic signals may be communicated and processed by a control system 714 (control circuitry, ASIC, processing apparatus, passive components, etc.) that is electrically and/or communicatively coupled with the sensor stack 700.

In some implementations, an area associated with the imaging portion 706 may be larger than an area associated with the sensing portion 712 of the sensor stack 700, by virtue of the acoustic lens as discussed above. The sensing portion 712 may be a surface of the sensor stack 700 associated with an acoustic transmitter element or an acoustic receiver element or an array thereof. The sensor stack 700 may therefore advantageously have a smaller footprint requiring lower power and cost than conventional sensor stacks since the area imaged obtained may be larger, which may improve the security and reliability associated with the imaging data (e.g., fingerprint data) and potentially enable more fingerprint data to be collected over the larger area.

### Additional Embodiments

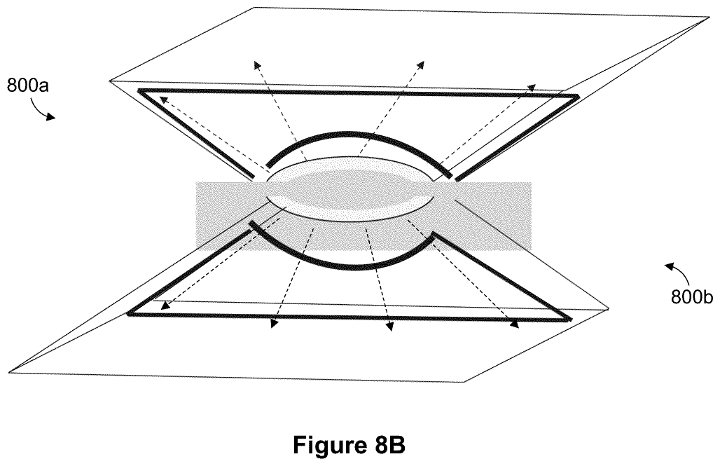

FIGS. 8A and 8B each show a diagram of a flexible acoustic sensor system using multiple acoustic lenses, according to some embodiments. As is sometimes the case with foldable displays or devices, multiple screen or platens may be present on a front side and a back side of such devices.

FIG. 8A depicts an example implementation of two sensing elements, two substrates, two acoustic lenses, and two platens, where they are each disposed opposite to each other. Each flexible acoustic sensor portion 800a, 800b may include one sensing element, one substrate, and one acoustic lens. Each flexible acoustic sensor portion 800a, 800b may be an example of flexible acoustic sensor system 500. However, in some cases, one substrate may be rigid and not flexible, while the other substrate may be flexible. In some cases, one platen may be rigid and not flexible, while the other platen may be flexible.

FIG. 8B depicts another example implementation of two sensing elements, two substrates, and two acoustic lenses, where they are each disposed opposite to each other. Alignment and position of the components may vary as illustrated in FIGS. 8A and 8B depending on, e.g., the locations of the imaging portions on each side of a device having multiple screens or platens on different (e.g., opposing) sides.

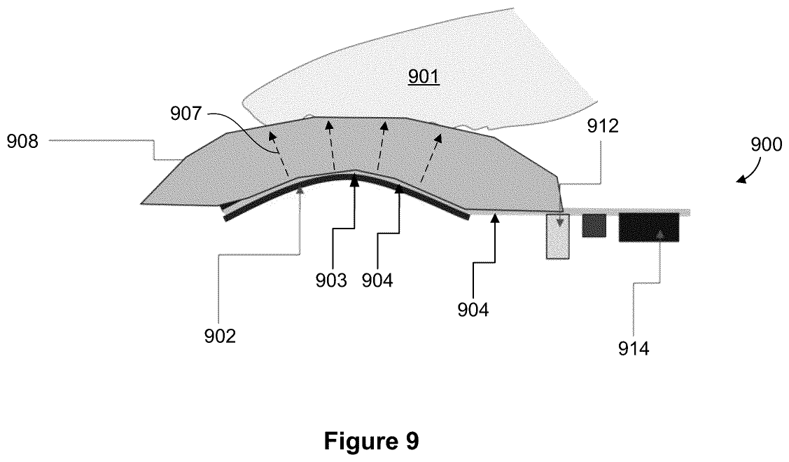

FIG. 9 is a cross-sectional diagram of a flexible acoustic sensor system 900 using a curved platen 908, according to some embodiments. In some embodiments, the acoustic sensor system 900 may include a sensing element 902 with a sensing portion associated therewith, e.g., at a surface of an acoustic transmitter element and/or an acoustic receiver element (or an array thereof) of the sensing element 902. In some embodiments, the acoustic sensor system 900 may further include a substrate 904, which may be a flexible substrate and an example of substrate 404 or substrate 504. The sensing element 902 and the substrate 904 may conform to a curved surface of the curved platen 908.

In some embodiments, the curved platen 908 may be constructed of a polymer, such as silicone rubber, polyethylene, polyethylene terephthalate (PET), polycarbonate, poly(methyl methacrylate) (PMMA). In some embodiments, the curved platen 908 may be constructed of glass or a ceramic material. In some embodiments, the curved platen 908 may have dimensions, curvature, angle, and other parameters that are dependent on the geometry of the device (e.g., flexible acoustic sensor system 900) that the curved platen 908 is implemented in. In some embodiments, the curved platen 908 may have a curvature that causes acoustic signals 907 traveling through the curved platen 908 toward an object of interest (e.g., a finger 901) to experience an altered, increased range of propagation angles. That is, the expanded propagation angle range may enable a larger imaging area associated with an imaging portion of the curved platen 908 compared to an area associated with the sensing portion of the sensing element 902.

In some embodiments, however, the curvature of the curved platen 908 may result in a 1:1 imaging area with the same or substantially same area as the sensing portion of the sensing element 902. Such 1:1 imaging may occur where the curvature of the curved platen 908 is the same or substantially the same as the curvature of the sensing element 902.

Nonetheless, as indicated in FIG. 9, by virtue of the curvature possessed by the curved platen 908, acoustic signals 907 may propagate from the sensing element 902 at an angle relative to one another, rather than parallel to one another as they would if emitted from a planar sensing element. Reflected acoustic waves may be collected by the sensing element 902 along the same paths as those taken by the transmitted acoustic signals 907. That is, while the propagation angle range is expanded during transmission, the propagation angle range is narrowed when receiving the acoustic signals.

In some implementations, the curved platen 908 may be implemented with a display. In some examples, the display may be a curved display element 903, such as a flexible display or a foldable display, which may be capable of bending, folding, or other distortions, or it may be fixed at, or as, a curved surface (such as the curved platen 908). In some configurations, the curved display element 903 may be disposed between the sensing element 902 and the curved platen 908, and may include components (not shown) such as a light-emitting layer (e.g., OLED), one or more adhesive layers (e.g., PSA layer and/or OCA layer), and/or a polarizing layer. In some cases, the curved platen 908 may function as a cover surface (e.g., cover glass or other materials listed above) for the curved display element 903, which may be disposed beneath the cover surface. In some implementations, the substrate 904 may be a flexible substrate as noted above, and constructed to conform to a curvature of the curved platen and the curved display element.

In some configurations, the substrate 904 may also include passive components 912, a control system 914 (e.g., control circuitry such as ASIC, a processor apparatus having one or more processors), and/or other components. These components may be electrically and/or communicatively coupled with at least the sensing element 902, enabling signal and/or data communication between the sensing element 902 and the components. For example, a transmit signal may be sent from the control system 914 to the sensing element 902 (e.g., to an acoustic transmitter element), and a receive signal from the sensing element 902 (e.g., from an acoustic receiver element) may be received at the control system 914.

In contrast to the embodiments and implementations relating to the flexible acoustic sensor system 400 or the flexible acoustic sensor system 500, an acoustic lens may not be used in some embodiments of flexible acoustic sensor system 900. In some scenarios, the curved platen 908 alone may allow usage of sensing element 902 with a curved surface (including of another object of a type listed elsewhere herein). In such embodiments, the curved platen 908 may be coupled with the sensing element 902, e.g., via an adhesive such as adhesive layer 624, and/or substrate 904.

However, in other embodiments, flexible acoustic sensor system 900 may further include an acoustic lens (not shown). Such an acoustic lens may have a curvature and/or parameters configured to alter or maintain the propagation angles and range for acoustic signals 507, similar to the acoustic sensor system 400 and the flexible acoustic sensor system 500. In some implementations, the curved platen 908 may not expand the imaging area (and would result in 1:1 imaging if used alone), but it may be the acoustic lens that expands the imaging area.

In some embodiments, time delays may be added to individual pixels associated with acoustic transmitter elements. By adding a time delay to certain pixels, acoustic (e.g., ultrasonic) waves may focus at certain points of convergence where there is constructive interference of the waves. This may induce a “lens effect” to the emitted acoustic signals, which may enable a stronger acoustic signal to be transmitted at points where acoustic signals constructively interfere. This approach may be advantageous in implementations where the performance of the transmitter elements is relatively lower than that of the receiver elements.

### Example Methods

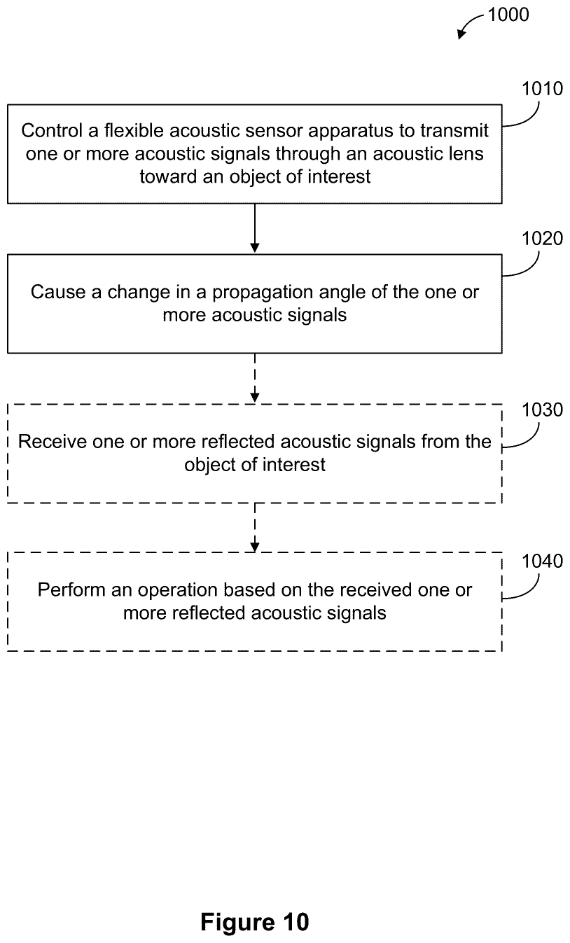

FIG. 10 is a flow diagram of an example of a method 1000 of operating a flexible acoustic sensor, according to some disclosed embodiments. Structure for performing the functionality illustrated in one or more of the blocks shown in FIG. 10 may be performed by hardware and/or software components, such as a control system, of an apparatus or system. Components of such apparatus or system may include, for example, an acoustic transmitter system, an acoustic receiver system, a control system (including one or more processors), a memory, and/or a computer-readable apparatus including a storage medium storing computer-readable and/or computer-executable instructions that are configured to, when executed by the control system, cause the control system, the one or more processors, or the apparatus or system to perform operations represented by blocks below. Example components of the apparatus or system are illustrated in, e.g., FIGS. 1, 4, 5, 6 and 9, which are described in more detail above.

The blocks of FIG. 10 may, for example, be performed by the apparatus 100 or by a similar apparatus, or a component thereof (e.g., a control system). As with other methods disclosed herein, the method outlined in FIG. 10 may include more or fewer blocks than indicated. Moreover, the blocks of methods disclosed herein are not necessarily performed in the order indicated. In some instances, one or more of the blocks shown in FIG. 10 may be performed concurrently.

At block 1010, the method 1000 may include controlling (e.g., by a control system, such as control system 106) a flexible acoustic sensor apparatus to transmit one or more acoustic signals through an acoustic lens toward an object of interest (e.g., a finger of a user). In some cases, one or more acoustic signals may be ultrasonic signals transmitted by one or more acoustic transmitter elements, such as the electrode layer 610. In some cases, the method 1000 may include transmitting one or more acoustic signals toward an object of interest through an acoustic lens and a platen. In some configurations, the platen may include a curved platen having a curved surface configured to contact a body part of a user.

Means for performing functionality at block 1010 may include the acoustic transmitter system 104, the control system 106, and/or other components of the apparatus as shown in FIG. 1.

At block 1020, the method 1000 may include causing a change in a propagation angle range of the one or more acoustic angles. In some cases, the acoustic lens may possess a curvature (and/or other properties or parameters) that expands the propagation angle range (e.g., spherically). The change in propagation angle may enable an area associated with an imaging portion of a surface of a platen which is larger than an area associated with a sensing element (e.g., an acoustic sensing element which may include the one or more acoustic transmitter elements and/or one or more acoustic receiver elements). The sensing element, in some implementations, may possess smaller dimensions than the imaging portion and/or a typical sensing element.

Means for performing functionality at block 1020 may include the acoustic lens 102, the flexible substrate 103, and/or other components of the apparatus as shown in FIG. 1.

Some implementations of method 1000 may include, at block 1030, receiving one or more reflected acoustic signals from the object of interest. The one or more reflected acoustic signals may be received at an acoustic sensing element of the acoustic sensor apparatus. In some cases, the one or more reflected acoustic signals may be ultrasonic signals detected and received by one or more receiver elements, such as one or more receiver pixels 605 of TFT circuitry 606, and the reflected acoustic signals may be representative of acoustic data, e.g., fingerprint data, from the imaging portion.

Means for performing functionality at block 1030 may include the platen 101, the acoustic receiver system 105, the control system 106, and/or other components of the apparatus as shown in FIG. 1.

Some implementations of method 1000 may include, at block 1040, performing an operation based on the received one or more reflected acoustic signals. In some examples, the object of interest may include a finger of a user, the one or more reflected acoustic signals may be representative of fingerprint imaging data, and the operation may include fingerprint sensing based on the fingerprint imaging data. As such, acoustic data may be used to identify the object of interest or a portion thereof, generate imaging data (e.g., fingerprint imaging data) and/or an image based on the imaging data (e.g., fingerprint image), change an operative state of a device using the acoustic data, perform an operation with the device (e.g., initialize an application, display data, etc.), etc., or a combination thereof.

Means for performing functionality at block 1040 may include the acoustic the control system 106 and/or other components of the apparatus as shown in FIG. 1.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

Various modifications to the implementations described in this disclosure may be readily apparent to those skilled in the art, and the generic principles defined herein may be applied to other implementations without departing from the spirit or scope of this disclosure. Thus, the following claims are not intended to be limited to the implementations shown herein, but are to be accorded the widest scope consistent with this disclosure, the principles and the novel features disclosed herein.

Additionally, certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. Moreover, various ones of the described and illustrated operations can itself include and collectively refer to a number of sub-operations. For example, each of the operations described above can itself involve the execution of a process or algorithm. Furthermore, various ones of the described and illustrated operations can be combined or performed in parallel in some implementations. Similarly, the separation of various system components in the implementations described above should not be understood as requiring such separation in all implementations. As such, other implementations are within the scope of the following claims. In some cases, the actions recited in the claims can be performed in a different order and still achieve desirable results.

Implementation examples are described in the following numbered clauses:

Clause 1: An apparatus comprising: a platen having an imaging portion associated with a surface of the platen; a flexible substrate comprising an acoustic sensing element; and an acoustic lens disposed between the platen and the flexible substrate, the acoustic lens having a curvature configured to expand a propagation angle range of one or more acoustic signals emitted from the acoustic sensing element such that an area associated with the imaging portion is larger than an area associated with the acoustic sensing element; wherein the flexible substrate is constructed to conform to the curvature of the acoustic lens.

Clause 2: The apparatus of clause 1, wherein the flexible substrate is composed of polyimide and comprises a thickness of 10 to 50 μm.

Clause 3: The apparatus of clause 1, wherein the flexible substrate is composed of a polymer material having a thickness of 10 to 50 μm, the polymer material comprising polyethylene terephthalate (PET), polyethylene naphthalate (PEN), thermoplastic polyurethane (TPU), polyestersulfone (PES), or colorless polyimide (CPI).

Clause 4: The apparatus of clause 1, wherein the acoustic lens is composed of silicone rubber, polydimethylsiloxane (PDMS), or room-temperature vulcanization (RTV) silicone.

Clause 5: The apparatus of clause 1, wherein the acoustic lens comprises a parameter that correlates to a physical parameter of the acoustic sensing element, the apparatus, or a combination thereof.

Clause 6: The apparatus of clause 1, wherein the platen at least partly comprises a display element.

Clause 7: The apparatus of clause 1, wherein: the acoustic sensing element comprises an acoustic transmitter element and an acoustic receiver element disposed proximate to the flexible substrate; and the surface of the platen is configured to contact a body part of a user.

Clause 8: The apparatus of clause 7, wherein: the acoustic transmitter element comprises an electrode layer disposed adjacent to a piezoelectric layer; and the acoustic receiver element comprises one or more pixelated receiver electrodes having associated thin-film transistor (TFT) circuitry.

Clause 9: The apparatus of clause 7, wherein: the acoustic transmitter element is configured to emit the one or more acoustic signals toward the body part of the user through the acoustic lens; and the acoustic receiver element is configured to detect one or more acoustic signals reflected from the body part of the user.

Clause 10: The apparatus of clause 7, wherein: the body part of the user comprises a finger, and the acoustic sensing element comprises a fingerprint sensor configured to obtain fingerprint data through the acoustic lens; and the apparatus further comprises a control system configured to perform an operation based on the fingerprint data.

Clause 11: The apparatus of clause 1, further comprising a second platen having a second imaging portion, a second acoustic lens disposed between the second platen and the acoustic sensing element; wherein: the platen and the acoustic lens are disposed proximate a first surface of the flexible substrate; the second platen and the second acoustic lens are disposed proximate a second surface of the flexible substrate, the second surface disposed substantially opposite the first surface of the flexible substrate; and the acoustic sensing element is configured to receive acoustic signals through the acoustic lens, the second acoustic lens, or a combination thereof.

Clause 12: The apparatus of clause 1, wherein: the platen comprises a curved platen having a curved surface configured to contact a body part of a user; and the flexible substrate is constructed to conform to a curvature of the curved platen.

Clause 13: An apparatus comprising: a curved platen comprising a curved surface having an imaging portion and configured to contact a body part of a user; and a flexible substrate comprising a sensing element; wherein: the flexible substrate is constructed to conform to a curvature of the curved platen; and the sensing element comprises: an acoustic transmitter element configured to emit one or more acoustic signals from the sensing element toward the body part of the user through the curved platen; and an acoustic receiver element configured to detect one or more acoustic signals reflected from the body part of the user at the imaging portion of the curved surface.

Clause 14: The apparatus of clause 13, wherein the curved platen is configured to expand a propagation angle of the one or more acoustic signals emitted from the acoustic transmitter element such that an area associated with the imaging portion of the curved platen is larger than an area associated with the sensing element.

Clause 15: The apparatus of clause 13, wherein the curved platen is configured to allow propagation of the one or more acoustic signals emitted from the acoustic transmitter element such that an area associated with the imaging portion of the curved platen is substantially equal to an area associated with the sensing element.

Clause 16: The apparatus of clause 13, further comprising an acoustic lens disposed between the curved platen and the flexible substrate.

Clause 17: The apparatus of clause 16, wherein the acoustic lens comprises a curvature configured to expand a propagation angle of the one or more acoustic signals emitted from the acoustic transmitter element such that an area associated with the imaging portion of the curved platen is larger than an area associated with the sensing element.

Clause 18: The apparatus of clause 16, further comprising an adhesive layer disposed between the acoustic lens and the flexible substrate.

Clause 19: The apparatus of clause 13, wherein the flexible substrate is composed of polyimide.

Clause 20: The apparatus of clause 13, wherein the flexible substrate is composed of a polymer material, the polymer material comprising polyethylene terephthalate (PET), polyethylene naphthalate (PEN), thermoplastic polyurethane (TPU), polyestersulfone (PES), or colorless polyimide (CPI).

Clause 21: The apparatus of clause 13, wherein the curved platen at least partly comprises a display element.

Clause 22: The apparatus of clause 13, wherein: the body part of the user comprises a finger, and the sensing element comprises a fingerprint sensor configured to obtain fingerprint data through the curved platen; and the apparatus further comprises a control system configured to perform an operation based on the fingerprint data.

Clause 23: The apparatus of clause 13, further comprising a curved display element disposed between the curved platen and the flexible substrate.

Clause 24: The apparatus of clause 13, wherein the curved platen comprises a material constructed of silicone rubber, polyethylene, polyethylene terephthalate (PET), polycarbonate, poly(methyl methacrylate) (PMMA), glass, or ceramic.

Clause 25: An acoustic sensing apparatus comprising: a platen configured to contact a body part of a user and comprising an imaging portion; an acoustic lens having a curvature configured to expand a propagation angle range of one or more acoustic signals emitted from the acoustic sensing element such that an area associated with the imaging portion is larger than an area associated with the acoustic sensing element; and a flexible substrate comprising an acoustic sensing element, wherein: the acoustic lens is disposed between the platen and the flexible substrate; and the acoustic sensing element comprises: an acoustic transmitter element configured to emit one or more acoustic signals toward the body part of the user through the acoustic lens and the platen; and an acoustic receiver element configured to receive, through the acoustic lens and the platen, one or more acoustic signals reflected from the body part of the user at the imaging portion.

Clause 26: The apparatus of clause 25, wherein: the platen comprises a curved platen having a curved surface configured to contact the body part of the user; the apparatus further comprises a curved display element disposed between the curved platen and the flexible substrate; and the flexible substrate is constructed to conform to a curvature of the curved platen and the curved display element.

Clause 27: The apparatus of clause 25, wherein: the body part of the user comprises a finger, and the acoustic sensing element comprises a fingerprint sensor; the one or more acoustic signals are received responsive to the emission of the one or more acoustic signals and representative of fingerprint imaging data; and the apparatus further comprises a control system configured to perform an operation using the fingerprint imaging data.

Clause 28: A method of operating an acoustic sensor apparatus, the method comprising: transmitting one or more acoustic signals toward an object of interest through an acoustic lens and a platen; receiving, at an acoustic sensing element of the acoustic sensor apparatus, one or more reflected acoustic signals from the object of interest; performing an operation based on the received one or more reflected acoustic signals; wherein the acoustic lens is configured to expand a propagation angle range of the one or more acoustic signals, and increase an imaging area of an imaging portion at the platen of the acoustic sensor apparatus to be greater than a sensing area associated with an acoustic sensing element.

Clause 29: The method of clause 28, wherein: the object of interest comprises a finger of a user; the one or more reflected acoustic signals are representative of fingerprint imaging data; and the operation comprises fingerprint sensing based on the fingerprint imaging data.

Clause 30: The method of clause 28, wherein the platen comprises a curved platen having a curved surface configured to contact a body part of a user.

What is claimed:

1. An apparatus comprising:
a platen having an imaging portion associated with a surface of the platen;
a flexible substrate comprising an acoustic sensing element; and
an acoustic lens disposed between the platen and the flexible substrate, the acoustic lens having a curvature configured to expand a propagation angle range of one or more acoustic signals emitted from the acoustic sensing element such that an area associated with the imaging portion is larger than an area associated with the acoustic sensing element;
wherein the flexible substrate is constructed to conform to the curvature of the acoustic lens.

2. The apparatus of claim 1, wherein the flexible substrate is composed of polyimide and comprises a thickness of 10 to 50 μm.

3. The apparatus of claim 1, wherein the flexible substrate is composed of a polymer material having a thickness of 10 to 50 μm, the polymer material comprising polyethylene terephthalate (PET), polyethylene naphthalate (PEN), thermoplastic polyurethane (TPU), polyestersulfone (PES), or colorless polyimide (CPI).

4. The apparatus of claim 1, wherein the acoustic lens is composed of silicone rubber, polydimethylsiloxane (PDMS), or room-temperature vulcanization (RTV) silicone.

5. The apparatus of claim 1, wherein the acoustic lens comprises a parameter that correlates to a physical parameter of the acoustic sensing element, the apparatus, or a combination thereof.

6. The apparatus of claim 1, wherein the platen at least partly comprises a display element.

7. The apparatus of claim 1, wherein:
the acoustic sensing element comprises an acoustic transmitter element and an acoustic receiver element disposed proximate to the flexible substrate; and
the surface of the platen is configured to contact a body part of a user.

8. The apparatus of claim 7, wherein:
the acoustic transmitter element comprises an electrode layer disposed adjacent to a piezoelectric layer; and
the acoustic receiver element comprises one or more pixelated receiver electrodes having associated thin-film transistor (TFT) circuitry.

9. The apparatus of claim 7, wherein:
the acoustic transmitter element is configured to emit the one or more acoustic signals toward the body part of the user through the acoustic lens; and
the acoustic receiver element is configured to detect one or more acoustic signals reflected from the body part of the user.

10. The apparatus of claim 7, wherein:
the body part of the user comprises a finger, and the acoustic sensing element comprises a fingerprint sensor configured to obtain fingerprint data through the acoustic lens; and
the apparatus further comprises a control system configured to perform an operation based on the fingerprint data.

11. The apparatus of claim 1, further comprising a second platen having a second imaging portion, a second acoustic lens disposed between the second platen and the acoustic sensing element;
wherein:
the platen and the acoustic lens are disposed proximate a first surface of the flexible substrate;
the second platen and the second acoustic lens are disposed proximate a second surface of the flexible substrate, the second surface disposed substantially opposite the first surface of the flexible substrate; and
the acoustic sensing element is configured to receive acoustic signals through the acoustic lens, the second acoustic lens, or a combination thereof.

12. The apparatus of claim 1, wherein:
the platen comprises a curved platen having a curved surface configured to contact a body part of a user; and
the flexible substrate is constructed to conform to a curvature of the curved platen.

13. An apparatus comprising:
a curved platen comprising a curved surface having an imaging portion and configured to contact a body part of a user; and
a flexible substrate comprising a sensing element;
wherein:
the flexible substrate is constructed to conform to a curvature of the curved platen; and
the sensing element comprises:
an acoustic transmitter element configured to emit one or more acoustic signals from the sensing element toward the body part of the user through the curved platen; and
an acoustic receiver element configured to detect one or more acoustic signals reflected from the body part of the user at the imaging portion of the curved surface.

14. The apparatus of claim 13, wherein the curved platen is configured to expand a propagation angle of the one or more acoustic signals emitted from the acoustic transmitter element such that an area associated with the imaging portion of the curved platen is larger than an area associated with the sensing element.

15. The apparatus of claim 13, wherein the curved platen is configured to allow propagation of the one or more acoustic signals emitted from the acoustic transmitter element such that an area associated with the imaging portion of the curved platen is substantially equal to an area associated with the sensing element.

16. The apparatus of claim 13, further comprising an acoustic lens disposed between the curved platen and the flexible substrate.

17. The apparatus of claim 16, wherein the acoustic lens comprises a curvature configured to expand a propagation angle of the one or more acoustic signals emitted from the acoustic transmitter element such that an area associated with the imaging portion of the curved platen is larger than an area associated with the sensing element.

18. The apparatus of claim 16, further comprising an adhesive layer disposed between the acoustic lens and the flexible substrate.

19. The apparatus of claim 13, wherein the flexible substrate is composed of polyimide.

20. The apparatus of claim 13, wherein the flexible substrate is composed of a polymer material, the polymer material comprising polyethylene terephthalate (PET), polyethylene naphthalate (PEN), thermoplastic polyurethane (TPU), polyestersulfone (PES), or colorless polyimide (CPI).

21. The apparatus of claim 13, wherein the curved platen at least partly comprises a display element.

22. The apparatus of claim 13, wherein:
the body part of the user comprises a finger, and the sensing element comprises a fingerprint sensor configured to obtain fingerprint data through the curved platen; and
the apparatus further comprises a control system configured to perform an operation based on the fingerprint data.

23. The apparatus of claim 13, further comprising a curved display element disposed between the curved platen and the flexible substrate.

24. The apparatus of claim 13, wherein the curved platen comprises a material constructed of silicone rubber, polyethylene, polyethylene terephthalate (PET), polycarbonate, poly(methyl methacrylate) (PMMA), glass, or ceramic.

25. An acoustic sensing apparatus comprising:
a platen configured to contact a body part of a user and comprising an imaging portion;
an acoustic lens having a curvature configured to expand a propagation angle range of one or more acoustic signals emitted from the acoustic sensing element such that an area associated with the imaging portion is larger than an area associated with the acoustic sensing element; and
a flexible substrate comprising an acoustic sensing element, wherein:
the acoustic lens is disposed between the platen and the flexible substrate; and
the acoustic sensing element comprises:
an acoustic transmitter element configured to emit one or more acoustic signals toward the body part of the user through the acoustic lens and the platen; and
an acoustic receiver element configured to receive, through the acoustic lens and the platen, one or more acoustic signals reflected from the body part of the user at the imaging portion.

26. The apparatus of claim 25, wherein:
the platen comprises a curved platen having a curved surface configured to contact the body part of the user;
the apparatus further comprises a curved display element disposed between the curved platen and the flexible substrate; and
the flexible substrate is constructed to conform to a curvature of the curved platen and the curved display element.

27. The apparatus of claim 25, wherein:
the body part of the user comprises a finger, and the acoustic sensing element comprises a fingerprint sensor;
the one or more acoustic signals are received responsive to the emission of the one or more acoustic signals and representative of fingerprint imaging data; and
the apparatus further comprises a control system configured to perform an operation using the fingerprint imaging data.

28. A method of operating an acoustic sensor apparatus, the method comprising:
transmitting one or more acoustic signals toward an object of interest through an acoustic lens and a platen;
receiving, at an acoustic sensing element of the acoustic sensor apparatus, one or more reflected acoustic signals from the object of interest;
performing an operation based on the received one or more reflected acoustic signals;
wherein the acoustic lens is configured to expand a propagation angle range of the one or more acoustic signals, and increase an imaging area of an imaging portion at the platen of the acoustic sensor apparatus to be greater than a sensing area associated with an acoustic sensing element.

29. The method of claim 28, wherein:
the object of interest comprises a finger of a user;
the one or more reflected acoustic signals are representative of fingerprint imaging data; and
the operation comprises fingerprint sensing based on the fingerprint imaging data.

30. The method of claim 28, wherein the platen comprises a curved platen having a curved surface configured to contact a body part of a user.
